(19) United States
(12) Patent Application Publication
(10) Pub. No.: US 2017/0208052 A1
(43) Pub. Date: Jul. 20, 2017

(54) HYBRID CLOUD FILE SYSTEM AND CLOUD BASED STORAGE SYSTEM HAVING SUCH FILE SYSTEM THEREIN

(71) Applicant: Hope Bay Technologies, Inc, Taipei (TW)

(72) Inventors: BEN-CHIAO JAI, Neihu dist. Taipei City (TW); CHUNG-HUNG CHIANG, Neihu dist. Taipei City (TW); JIA-HONG WU, Neihu dist. Taipei City (TW); CHING-TE PANG, Neihu dist. Taipei City (TW)

(21) Appl. No.: 15/001,176

(22) Filed: Jan. 19, 2016

(51) Int. Cl. H04L 29/06; H04L 29/08; G06F 17/30

(52) U.S. Cl. CPC H04L 63/08; G06F 17/30203; G06F 17/30345; G06F 17/30126; H04L 67/1097; H04L 67/2842

(57) ABSTRACT

A hybrid cloud file system enabling a cloud storage volume with a cache storage utilizing local storage media is provided. Files in the hybrid cloud file system are substantially uploaded and stored into a cloud storage server and presented as no difference as storing in a local storage volume. Portion of the local storage media may be allocated as a cache storage storing files to be accessed locally for accelerate data fetching and processing. Besides uploading, fetching and deleting, deduplication mechanism before uploading and prefetch mechanism during/before data fetch are also provided in the present disclosure.

### CROSS-REFERENCE TO RELATED APPLICATIONS

The present application is related to the following application: U.S. patent application Ser. No. ______ (Attorney Docket Number: 2015WI0133-03), entitle “METHOD AND APPARATUS FOR DATA DEDUPLICATION IN CLOUD BASED STORAGE SYSTEM”, filed on Jan. 18, 2016, which is currently co-pending; U.S. patent application Ser. No. (Attorney Docket Number: 2015WI0133-04), entitle “METHOD AND APPARATUS FOR DATA PREFETCH IN CLOUD BASED STORAGE SYSTEM”, filed on Jan. 19, 2016, which is currently co-pending.

### TECHNICAL FIELD

At least one embodiment of the present invention pertains to cloud computing, and more particularly, to cloud-based storage system for electronic devices.

### BACKGROUND

Cloud storage service provides data storage space to host user files, thus enabling a user to upload files to the cloud storage service and access the uploaded files at a later time using the same or different client device. However, remote access of data content from a cloud service takes manual operation which costs time and brings inconvenience.

Within present disclosure, solutions are provided and not limited to the situations; as well, extensive applications may not be exhaustively described within the scope of present disclosure.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an exemplary cloud storage system in accordance with some embodiments of the present disclosure.

FIG. 2 is a schematic diagram illustrating an exemplary operating system associated with a client device and a cloud storage cluster of cloud storage system.

FIG. 3 is a schematic diagram illustrating an exemplary operating system of the client device 100 in accordance with some embodiments of the illustration in FIG. 2.

FIG. 4 is a schematic diagram illustrating exemplary network architecture of the cloud storage system in accordance with some embodiments of the present disclosure.

FIG. 5A is a functional block diagram illustrating an exemplary client device.

FIG. 5B is a schematic diagram illustrating an exemplary client device as a peripheral device to another computing device.

FIG. 6 illustrates a data arrangement in a cloud storage system in accordance with some embodiments of the present disclosure.

FIGS. 7A, 7B and 7C are flow charts illustrating exemplary configuring processes of a client device in accordance with some embodiments of the present disclosure.

FIGS. 8A and 8B are flow charts illustrating exemplary data storing processes of a client device in accordance with some embodiments of the present disclosure.

FIGS. 8C and 8D are flow charts illustrating an exemplary data storing process with data deduplication of a client device in accordance with some embodiments of the present disclosure.

FIGS. 8E and 8F are flow charts illustrating an exemplary data storing process with data deduplication of a deduplication server in accordance with some embodiments of the present disclosure.

FIGS. 9A and 9B are flow charts illustrating exemplary data fetch processes of a client device in accordance with some embodiments of the present disclosure.

FIG. 9C is a flow chart illustrating an exemplary data fetch process with data prefetch of a client device in accordance with some embodiments of the present disclosure.

FIG. 9D is a flow chart illustrating an exemplary data editing/updating process of a client device in accordance with some embodiments of the present disclosure.

FIG. 10 is a flow chart illustrating an exemplary data deleting process of a client device in accordance with some embodiments of the present disclosure.

FIG. 11A illustrates an exemplary data prefetch plan in accordance with some embodiments of the present disclosure.

FIG. 11B illustrates an exemplary data prefetch plan in accordance with some embodiments of the present disclosure.

FIG. 11C illustrates an exemplary data fetch pattern for optimizing data prefetch plan in accordance with some embodiments of the present disclosure.

FIG. 12 is a flow chart illustrating an optimizing process of a data prefetch plan in accordance with some embodiments of the present disclosure.

### DETAILED DESCRIPTION

For consistency purpose and ease of understanding, like features are identified (although, in some instances, not shown) with like numerals in the exemplary figures. However, the features in different embodiments may differ in other respects, and thus shall not be narrowly confined to what is shown in the figures.

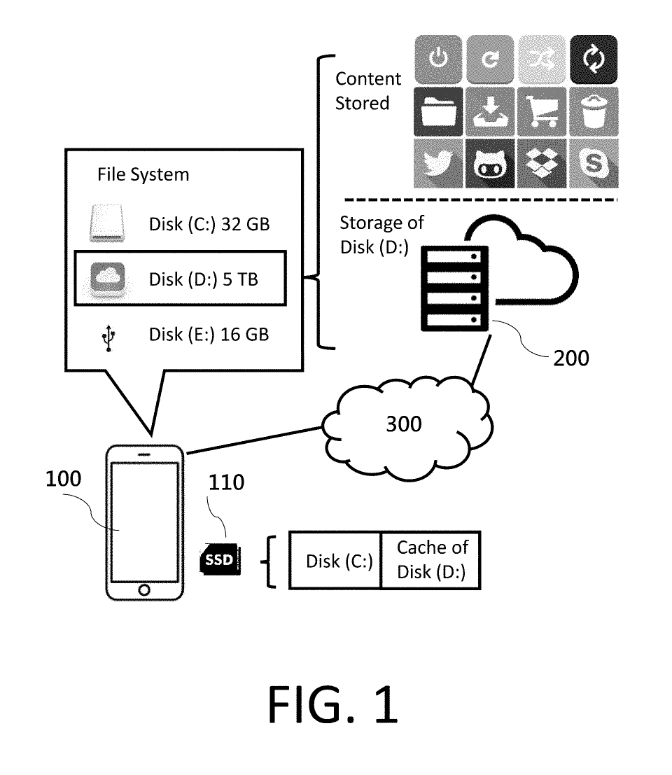

FIG. 1 illustrates an exemplary cloud storage system in accordance with some embodiments of the present disclosure. The exemplary cloud storage system may include a client device 100 capable of sending/receiving different type of data contents in a cloud storage server cluster 200 over a network 300. The aforementioned data contents refer to some structured data information stored in a file system; e.g. a continuous chunk of a content data (e.g., a block/fragment of a file), one or more files, or one or more folders. To achieve a higher degree of efficiency and reliability for file transferring over a data network, it may be desirable to break/partition an electronic file (e.g., a media stream) into small fragments/partitions and transfer them between the cloud server and the client devices. For instance, a file system object (e.g. a file or directory-listing) may be broken/partitioned down into chunks (blocks) of size up to a fixed limit for network transmission, and/or storage purpose (locally or in the storage backend). Transmission (in either direction from or to a backend storage) and the location (e.g. whether there exists a local copy in the client device) of a block may be independent of the other blocks (in the same file system object or not), or may be grouped for performance.

Referring to FIG. 1 again, the client device 100 may correspond to a file system having one or more storage volumes depicted as “Disk (C:)”, “Disk (D:)” and “Disk (E:)” in FIG. 1. Each volume may correspond to different storage medium. For example, the client device 100 may comprise a local storage medium 110 presented as the “SSD” icon with its storage arrangement presented in the right of the icon in FIG. 1. Portion of the local storage medium 110 may be allocated for the storage volume “Disk (C:)” having a size of 32 Giga Bytes. The storage volume “Disk (E:)” may correspond to an external storage medium such as a computer peripheral storage device with a USB (Universal Serial Bus) port. The storage volume “Disk (D:)” having significantly larger size may correspond to a storage volume allocated for the client device 100 in the cloud storage server cluster 200. Contents stored in the allocated storage volume in the cloud storage server cluster 200 may be presented as stored in the storage volume “Disk (D:)” in the operating system of the client device 100. Manual operations of data storing and accessing to a file in the storage volume “Disk (D:)” may have no difference with a file in the storage volume “Disk (C:)” and “Disk (E:)”. Therefore, a user of the client device 100 may not even notice that the physical location of the content stored in the storage volume “Disk (D:)”. In addition, the size of the storage volume “Disk (D:)” may be flexibly arranged by adjusting allocated storage volume in the cloud storage server cluster 200 in the state of art of cloud computing technology and cloud storage service model. The cloud storage system in accordance with the instant disclosure may enable user experience of a significantly larger storage volume in the client device 100 than its onboard components physically provided therein. In some embodiments, a portion of the local storage medium 110 may be allocated as a cache volume for the storage volume “Disk (D:).” In such instances, a portion of data contents stored in the cloud storage server cluster 200 may be copied and stored in the cache volume to accelerate data accessing.

The client device 100 may be a personal computer, a laptop computer, a personal data assistant, a cell phone, an automobile computer, a game console, a smart phone, or other computing devices capable of running software application and capable of accessing network. The network 300 may be any type of data network, including the Internet, a cellular network, a local area network, a wide area network, any other comparable network, or a combination thereof. Communication over the network may be conducted over a combination of wired and wireless arrangements.

The cloud storage server cluster 200 may be one or more servers in any physical and virtual arrangement. In some implementations, the cloud storage server cluster 200 may be implemented in a single geographical location with each of the one or more servers communicably connected. In some implementations, the cloud storage server cluster 200 may be implemented in a distributed computing environment that utilizes several computer systems and components that are interconnected via wired/wireless communication links, using one or more computer networks or direct connections. In some implementations, the cloud storage server cluster 200 may be one or more virtual machines built on a software-defined resource pool provided by computing devices in multiple geographical locations. In some implementations, portions of the cloud storage server cluster 200 may selectively adopt the aforementioned physical and the virtual arrangements.

The client device 110, as well as the cloud storage server cluster 200, may typically include an operating system that provides executable program instructions for the general administration and operation of that device (e.g. the client device 100, servers of the cloud storage server cluster 200). In addition, the local storage medium 110 may be non-transitory computer-readable media storing instructions that, when executed by a processor of the device, allow the device to perform its intended functions. Suitable operating system for each of the devices may differ depending on the type and nature of the device. For instance, the client device 100 may be a personal computer running on a commercially available Windows™ operating system; the client device 100 may also be a cellular phone running on an Android operating system; while the cloud storage server cluster 200 may be operating on a Linux based operating system. Suitable implementations for the operating system and general functionality of the servers may be known or commercially available and are readily implemented by persons having ordinary skill in the art, particularly in light of the disclosure herein.

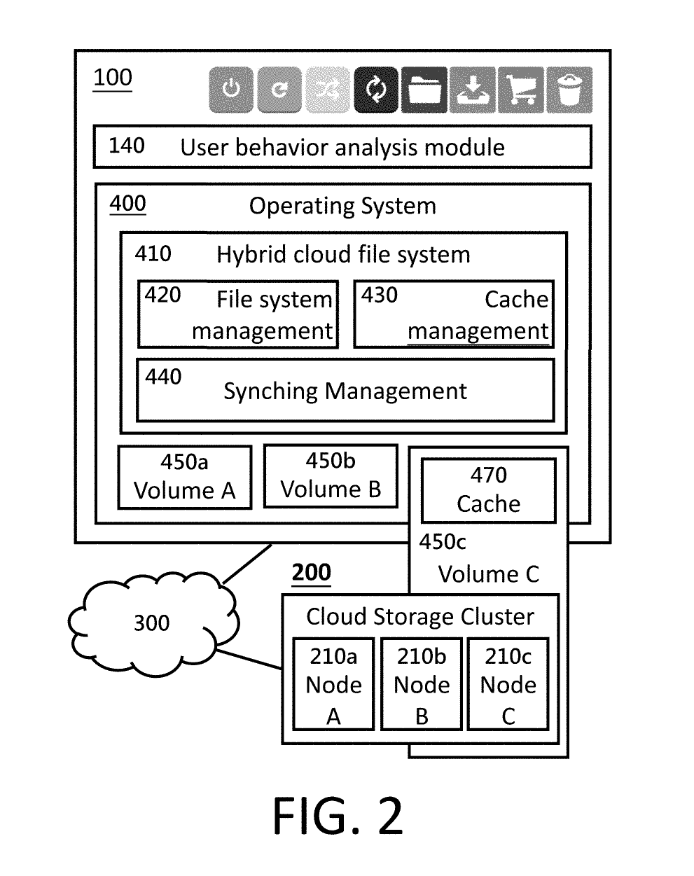

FIG. 2 illustrates an exemplary operating system associated with the client device 100 and a cloud storage cluster 200 of cloud storage system in accordance with some embodiment of the present disclosure. In the client device 100, an exemplary operating system 400 may be provided capable for managing the hardware resources of the client device 100 and providing services for running applications (e.g., mobile applications running on mobile devices). In some implementations, the operating system 400 and the application software may be stored in a local storage medium of the client device 100 such as the local storage medium 110. In some implementations, the operating system 400 may also be stored in the cloud storage server cluster 200 providing for download into the client device 100 and executed by the client device 100 at stage of booting up.

The application software may also be stored in the cloud storage server cluster 200 providing for download after booting up. In some implementations, the applications stored in the client device 100 may include applications for general productivity and information retrieval, including email, calendar, contacts, and weather information, or include applications in other categories, such as gaming, GPS and other location-based services, banking, order-tracking, ticket purchases or any other categories as contemplated by a person having ordinary skill in the art. In some implementations, the applications stored in the client device 100 may provide functions related to operating system 400. For example, a user behavior analysis module 140 for collecting data access patterns of data access operations performed by the operating system 400 and sending to the cloud storage server cluster 200 for various analyses.

The cloud storage server cluster 200 may include one or more storage nodes 210a, 210b and 210c. Each of the storage nodes 210 may contain one or more processors and storage devices. The storage devices may include optical disk storage, RAM, ROM, EEPROM, flash memory, phase change memory, magnetic cassettes, magnetic tapes, magnetic disk storage or any other computer storage medium that can be used to store data content.

Referring to FIG. 2 again, the exemplary operating system 400 of the client device 100 may be provided including a hybrid cloud file system 410 and one or more storage volumes depicted as 450a, 450b and 450c. The storage volume 450c may be defined and provided by an authorized storage volume in the cloud storage server cluster 200 via the network 300. In some implementations, a cache storage 470 may be allocated corresponding to the local storage medium 110. In some implementations, as depicted in FIG. 2, the cache storage 470 may be a data storage space virtually defined in the storage volume 450 which corresponds to the local storage medium 110. In some implementations, other than what depicted in FIG. 2, the cache storage 470 may also be an independent data storage space virtually defined and corresponding to the storage volume 450. The cache storage 470 may be defined to provide the hybrid cloud file system and the storage volume 450 a buffering region that is similar in concept to the page file in a memory management system. The data contents stored in the storage volume 450c may be uploaded to the cloud storage server cluster 200, and a copy of data contents may be stored in the cache storage 470 for accelerating access by directly access the copy in the cache storage 470. Space of cache storage 470 is far limited comparing to the storage volume in the cloud storage server cluster 200. Therefore, a space releasing mechanism may be applied. That is, data contents in the cache storage may be allowed to be overwritten and replaced by other data contents. In some implementations, a storage locking mechanism may be provided in the cache storage 470. That is, locked data may be kept and not overwritten in the cache storage 470 while unlocked data not kept and allowed to be overwritten. Data contents in the cache storage 470 may be assigned to be locked for accelerating access. Usually, a verb “pin” may be used for describing the operation of locking. A pinned data content may always be kept in cache storage 470 for accelerating access and not be allowed to be overwritten. Similarly, another term “unpin” may be used for describing the operation of unlocking. A pinned data content may be unpinned to release the space by allowing to be overwritten.

In some embodiments, the cache storage 470 may be shared by multiple storage volumes. For example, a shared cache storage 470 may be defined and assigned to the storage volumes 450a, 450b and 450c. Data contents in the storage volumes 450a, 450b and 450c may be allowed to be temporarily stored in the cache storage 470 to accelerate data accessing. The aforementioned “pin”/“unpin” mechanism may also be applied in the cache storage 470. In some implementations, a space in the local storage medium 110 may be allocated for the cache storage 470. Similarly, in some implementations, spaces in multiple local storage media including the local storage medium 110 may also be allocated for the cache storage 470. In some embodiments, when more than one cloud storage volumes are created for the client device 100 (the physical storage capacity of which correspond to storage volume in the cloud), the single local cache storage 470 may also be assigned for the plurality of newly created cloud storage volumes.

The hybrid cloud file system 410 may comprise a file system management module 420 for managing data contents in the storage volumes 450 and a synching management module 440 for managing data synchronization between the client device 100 and the cloud storage server cluster 200. The file system management module 420 may receive commands for data manipulations from the user interface and update the directory information accordingly. The synchronization management module 440 may manipulate the data stored in the cloud storage server cluster 200 according to the commands including data storing, data fetching, data updating and data deleting. The synchronization management module 440 may generate data manipulation request according to the commands and send to the cloud storage server cluster 200 for performing accordingly. In some implementations, applications may read data from or write data to the files as if the files are stored in the storage volumes 450. The file system management module 420 may receive read/write requests during the performance of the applications, and the synching management module 430 may retrieve the content data of the file from the cloud server 250 to satisfy the read or write requests. For example, the file management module 420 may receive a command for processing a file from a specific location in the storage volume 450c. The synchronization management module 440 may send a request for downloading the file and receiving the file from the cloud storage server cluster 200 for data processing. If any update occurs during data processing, the file management module 420 may further receive a command for storing the updated file into a specific destination (or data path) in the storage volume 450c. The synchronization management module 440 may further send an uploading request with the file to the cloud storage server cluster 200 for storing in the allocated storage volume in the cloud storage server cluster 200. The file management module 420 may further record the data storing into the destination and updating directory information corresponding to the storage volume 450c accordingly.

In some embodiments, a cache management module 430 for managing data contents in the cache storage 470 may also be included in the hybrid cloud file system 400. The file system management module 420 may receive commands for data manipulations from the user interface and update the directory information accordingly. The cache management may fetch/store the data in the cache storage 470 for accelerating data access or as a local buffer before the data uploading to the cloud storage server cluster. For example, the file management module 420 may receive a command for processing a file from a specific location in the storage volume 450c. The cache management module 430 may allocate a space in the cache storage 470 for the file and the synchronization management module 440 may obtain the file from the cloud storage server cluster 200. If any update occurs during data processing, the cache management module 430 may update the file in the cache storage 470. The synchronization management module 440 may further send an uploading request with the file to the cloud storage server cluster 200, and the file management module 420 may further update directory information accordingly. In some implementations, the cache management 430 may further configure data contents to be pinned/unpinned for space management. The cache management 430 may only release the storage of unpinned data contents in the cache storage 470 by allowing the unpinned data contents to be overwritten.

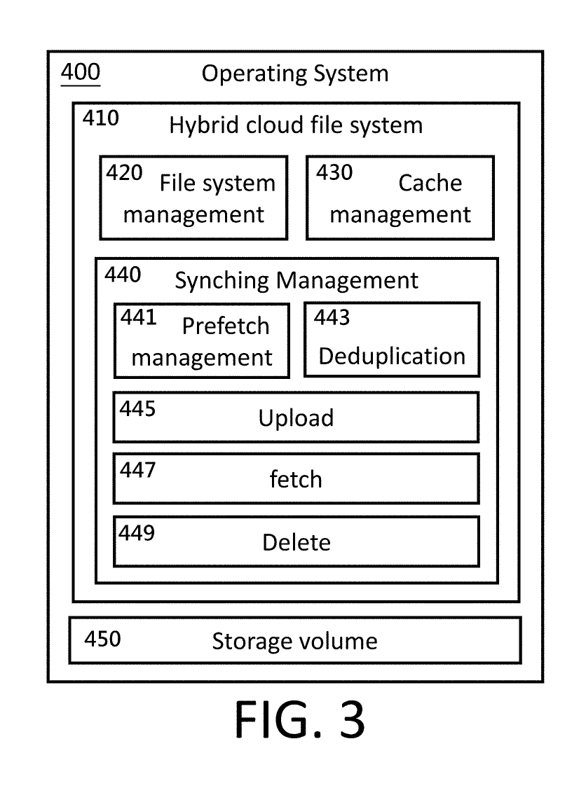

FIG. 3 further illustrates the exemplary operating system in FIG. 2 in accordance with some embodiment of the present disclosure. The synching management module 440 may further comprise a prefetch management component 441 for determining a prefetch plan to fetch data contents before being initiated by a user, a deduplication component 443 for checking duplicated data contents for data compression, an upload management component 445 for uploading data contents to the cloud storage server cluster 200 according to an uploading policy, a fetch management component 447 for downloading requested data contents from the cloud storage server cluster 200 according to user command or the prefetch plan and a delete management component 449 for deleting data contents from the local storage medium 110 and the cloud storage server cluster 200.

Referring to FIG. 3, the prefetch management component 441 may determine a prefetch plan indentifying particular data contents having a high probability to be accessed by the applications. A prefetch operation in accordance with some embodiments of the present disclosure is to download data files from the cloud storage server cluster 200 before being initiated by user actions. Because in a cloud storage environment, the data content of a file is typically stored in the cloud storage server cluster 200, the file access may take a longer time. To alleviate this situation, the prefetch management component 441 of the client device 100 may possess the ability to identify the data content of a file that are likely to be accessed by the user, and may accordingly prefetch the data content and store them in locally defined cache storage 470 in the client device 100. The prefetch plans may be used to identify the storage objects that are likely to be used based on a usage pattern of the storage objects. Moreover, different prefetch plans may be generated for multiple devices associated with the same or different user. The cache management module 430 may further initiate caching certain data contents into the local storage medium 110 according to the prefetch plan.

In some embodiments, metadata of the electronic files (e.g. descriptions, parameters, priority, date, time, and other pertinent information regarding data content.) may be stored in the storage volume 450, while the content of the files may be stored in the cloud storage server cluster 200. The file system management module 420 may present the files to the applications and users of the client device as if the content data are stored locally. On the other hand, the prefetch management component 441 may be responsible for retrieving content data from the cloud storage server cluster 200 as cache data to accelerate data access based on the metadata, access pattern and other factors of the data contents. In some implementations, the user behavior analysis module 140 in FIG. 2 may collect the aforementioned access pattern for the prefetch management component 441 to determine and update the prefetch plan accordingly.

Referring to FIG. 3 again, the deduplication component 443 may determine whether a data content to be stored in the cloud storage server cluster 200 is duplicated with another data content already stored in the cloud storage server cluster 200. A deduplication operation in accordance with some embodiments of the present disclosure is to store a pointer to the aforementioned duplicated data content already stored in the cloud storage sever cluster 200 instead of the data content itself when the data content to be stored is duplicated with another data content in the cloud storage sever cluster 200. The purpose of the deduplication is to minimize the total storage space required for storing data contents having duplicated portions. Instead of storing all of the duplicated portions, storing one copy of the duplicated portions and pointers for identifying and retrieving the copy may significantly save the total space. The deduplication operation may generally be expressed in two simplified steps: finding data content collision (data contents that are duplicated with another) and storing a copy for a collided data content and pointers (e.g. the address of the copy) along with identifications (e.g. metadata of a file) for other collided data contents instead. Hashing is often applied in finding data content collision. A hash may be a transformation of a string of characters (e.g., data contents) into a shorter fixed-length value or key that represents the original string. In some embodiments, hashing is used to index and retrieve data contents in the cloud storage server cluster 200. It is generally faster to find a data content using the shorter hashed index. In some embodiments, a hashing function is used to create an indexed version of the represented value corresponding to data contents. A Hash function may utilize non-encrypted schemes such as division-remainder method, folding, radix transformation, digit rearrangement, or encrypted schemes such as MD2, MD4, MD5, the Secure Hash Algorithm (SHA), and the like. For example, in one embodiment, a file may be partitioned into a fixed sized (e.g. 2 megabytes) data chunks as data contents, while hash data having a smaller size (e.g. 256 kilobits) may be respectively generated corresponding to the data contents.

In some embodiments, the exemplary the deduplication component 443 may be configured to generate a hash associated with a corresponding data content (e.g., a block/chunk of data of a file) to be upload to the cloud storage server cluster 200. The deduplication component 443 may send the hash to the cloud storage server cluster 200 for checking data collision before uploading the data content. If no data collision occurs, the client device 100 may upload the data content to the cloud storage server cluster 200. If data collision occurs, there would be no need to upload the duplicated data content to the cloud storage server cluster 200. The cloud storage server cluster 200 may store a pointer along with an identification of the data content instead of storing the data content itself. In some implementations, a deduplication policy may be maintained by the deduplication component 443. The deduplication policy may define one or more rules dictating whether to perform deduplication operation by the client device 100. For example, some client devices may lack the necessary computing power for generating a hash for data contents to be uploaded. In such instances, the deduplication component 443 may upload the data content to the cloud storage sever cluster 200 directly, so as to delegate the hashing generation and collision checking tasks to the cloud storage sever cluster 200 (e.g., server-side hash generation). Other factors may also be involved in the deduplication policy such as bandwidth availability for the client device 100. In some embodiments, multiple client devices in accordance with the present disclosure may access the cloud storage server cluster 200. Storage volumes may be respectively allocated for the client devices storing data contents. In some implementations, a copy of the non-duplicated data contents may be reserved among the allocated storage volumes for the deduplication operation. Metadata of data contents in the respective client devices may be uploaded to the cloud storage server cluster 200 as a reference for identifying collided data contents belong to the respective data contents. In some implementations, an identification generated from the metadata of the collided data contents and a pointer for accessing a copy of the collided data contents stored independently may be stored for replacing other collided data contents. Therefore, a global deduplication operation for different storage volumes (e.g. storage volume 450c) of different client devices (e.g. client device 100) may be provided.

The upload management component 445 may send data contents to be stored in the cloud storage server cluster 200. The upload management component 445 may also maintain an uploading policy containing rules determining whether/when to upload data contents to the cloud storage server cluster 200. The uploading policy may also be associated with several factors such as bandwidth available for the client device 100, battery level of the client device 100 and available cache storage 470. For example, the upload management component 445 may upload the data contents to the cloud storage server cluster 200 while bandwidth available for the client device 100 accessing the internet meeting a specific level. The upload management component 445 may also upload data contents to the cloud storage server cluster 200 only if battery level of the client device 100 exceeds a specific level. In addition, the upload management component 445 may upload data contents to the cloud storage server cluster 200 if the available space for cache storage 470 is under a specific level.

The fetch management component 447 may download data contents to be processed or prefetched from the cloud storage server cluster 200. In some implementations, the data contents downloaded may be temporarily kept in memory of the client device 100 and/or stored in the cache storage 470. The fetch management component 447 may request data contents from the cloud storage server cluster 200 according to a download request from the user. The fetch management component 447 may further request data contents the prefetch plan maintained by the prefetch management component 441.

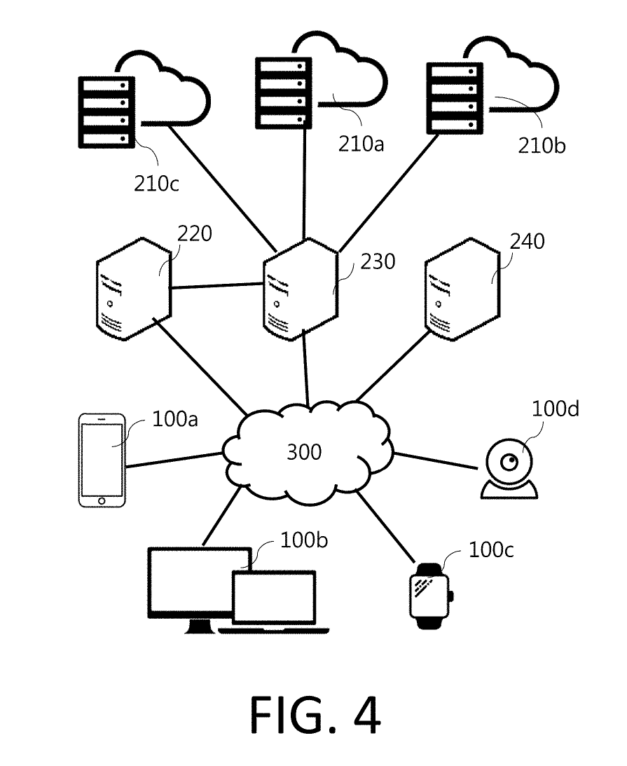

FIG. 4 illustrates exemplary network architecture of the cloud storage system in accordance with some embodiments of the present disclosure. Although the exemplary environment is presented as an Internet-based environment for purposes of explanation, it should be understood that different network environments may be used, as appropriate, to implement various embodiments. The exemplary environment includes a plurality of client devices 110a-d capable of sending/receiving different type of data content over the network 300. The client devices may include a smart phone 110a capable of running mobile applications and accessing files through the mobile applications, a laptop computer 110b capable of accessing and processing files through a file system implemented therein, a wearable device 110c having sensors for collecting data and limited resources for processing only collected data, a web camera 110d collecting large sized video data and generally having no local storage for the video data, and the like.

The cloud storage sever cluster 200 (not shown in FIG. 4) may include one or more storage nodes 210a-c having storage devices for storing data. Storage volumes in each storage node 210 may be aggregated and allocated for each client device 100. The total storage capacity may be extended by implementing more storage nodes. A management server 220 may serve allocating storage volumes provided by the storage nodes 210 for each of the client devices 100a-d. In some embodiments, the management server 220 may be operable, through logic associated therewith, to receive instructions from the client devices 100a-d and obtain, update, or otherwise process data in response thereto. For instance, a user may submit a request for a certain type of data content. The management server 220 may access the user information to verify the identity of the user and grant permission to access the data content stored in the storage nodes 210. The data content may then be returned to the user's client device in a timely and efficient manner as if the data content is hosted locally onboard the client device.

A deduplication server 230 may be arranged between the storage nodes 210 and the client devices 100a-d. In a cloud storage system where the associated storage hardware equipment is costly and the network bandwidth resource is scarce, the implementation of the deduplication server 230 may collaboratively provide data deduplication capabilities that facilitates effective utilization of existing storage capacity and reduces the bandwidth requirement in a cloud-based system. The deduplication server 230 may cooperate with the deduplication component 443 of the client devices 100a-d depicted in FIG. 3. By way of example, the addition of a deduplication mechanism in the cloud storage system is able to reduce the required storage capacity since only the unique data/file is stored. Aside from the benefit of storage space saving, equipment acquisition costs, power consumptions, device cooling requirements, and network bandwidth requirements may be reduced.

The deduplication server 230 may maintain a hash table corresponding to all unique data contents (depicted as “objects” in the following paragraph) stored in the storage nodes 210a-c. The hash table may include the hash values and identification corresponding to the objects. The deduplication server 230 may further be provided with a hash checking function configured to process the hash data generated by the deduplication component 443 from the client device 100. Upon the receipt of the hash data from the client device 100, the deduplication server 230 may detect that if a given hash value corresponding to an object already exists in the hash table. If the hash data comparison indicates that a hash value of a particular data content is unique (e.g., not yet exists in the hash table), the deduplication server 230 may request the data content associated with the unique hash value from the client device 100 and forward the non-duplicated data content to the storage nodes 210a-c (or management server 220 for arranging storage node) for storage. The deduplication server 230 may further generate identification to the unique data content and record the identification and the hash value corresponding to the unique data content in the hash table. In other words, the deduplication 230 may update the hash table by amending the unique data content as a new object. Conversely, if a duplication check detects that a hash value already exist in the deduplication namespace (the hash table) and therefore indicates a duplication, there will be no need to waste valuable network bandwidth resources in uploading the duplicated content data (associated with a non-unique hash data). In this case, the deduplication server 230 may not request the duplicated content data from the client device 100, but instead, store the associated hash data and information thereof for future indexing reference. Accordingly, the deduplication mechanism of the purposed cloud-based storage system may perform data duplication check efficiently at substantially lower level of bandwidth consumption. The bandwidth-resource conscience approach in accordance with embodiments of the present disclosure may be particularly beneficial for a mobile cloud environment. In some implementations, the deduplication server 230 may receive data contents to be stored in the storage nodes 210a-c instead of the hash value from the client device 100. The deduplication server 230 may therefore generate a hash value from the data content received and compare to the hash values in the hash table for checking data duplication.

In some implementations, a user behavior analysis server 240 may be contained in the cloud storage server cluster 200. The user behavior analysis server 240 may collaborate with the user behavior analysis module 140 of the operating system 400 in the client devices 100a-d to collect and analysis file access behavior. The analysis may be applied for improving the prefetch plan by providing the analysis to the prefetch management component 441. For instance, the user behavior analysis module 140 may collect file access behavior/pattern and send to the user behavior analysis server 240 for statistics. The user behavior analysis server 240 may generate/update rules in associate with data contents prefetch based on the statistics and send to the prefetch management component 441 for updating the prefetch plan accordingly. In some embodiments, the user behavior analysis server 240 may also operate to collect user behavior independently by obtaining file access behavior/access form the storage nodes 210 a-c or management server 220.

In some embodiments, additional servers may be included in the cloud storage server cluster 200. For instance, the system environment may include a web server (not shown) for receiving requests from user devices and serving content thereto in response. The cloud storage server cluster 200 may further include an application server (not shown), which includes appropriate hardware and software for integrating with the data stored therein as needed to execute aspects of one or more applications for the client device and handling a majority of the data access and business logic for an application. The handling of data requests and responses, as well as the delivery of content between one or more client devices (e.g. the client device 110) and the cloud storage server cluster 200, may be handled by the web server.

In some implementations, the storage nodes 210a-c may store separate data tables, databases, or other data storage mechanisms and media for storing data contents originated from the client device 110. For example, the storage nodes 210a-c may include mechanisms for storing data content such as audio files, video files, game files, and electronic document contents, user information, licensing information, device profile information and the like, and allowing the user of the client device to access the stored data content at a later time using a variety of different equipment. It should be understood that there can be many other types of data content stored in such the storage nodes 210a-c, such as page image information and access rights information, which can be stored in any of the above listed mechanisms as appropriate or in additional mechanisms in the cloud server.

An environment such as that illustrated in FIG. 4 is often referred to as a “cloud computing” environment, as various operations can occur on behalf of the user on one or more devices that may be distributed across various appliances, locations, and/or geographical regions, referred to as being performed “in the cloud.” By storing information and data content in such a distributed environment, and offloading at least some computations or operations to remote systems or services, a client device can offer more functionality than would otherwise be possible or practical by using the device alone. For example, the client devices 100a-d may respectively comprise only an economic small volume local storage device that has a limited data storing capacity. Nevertheless, upon connecting with the storage nodes 210, the large storage volume of the cloud server may be integrated as virtual add-on storage for the local storage device, thereby significantly expanding the data storing capability of the client device. It should be appreciated that such a system could operate equally well in a system having fewer or a greater number of components than are illustrated in FIG. 4. Thus, the depiction of the system in FIG. 4 should be taken as being illustrative in nature and not limiting to the scope of the disclosure.

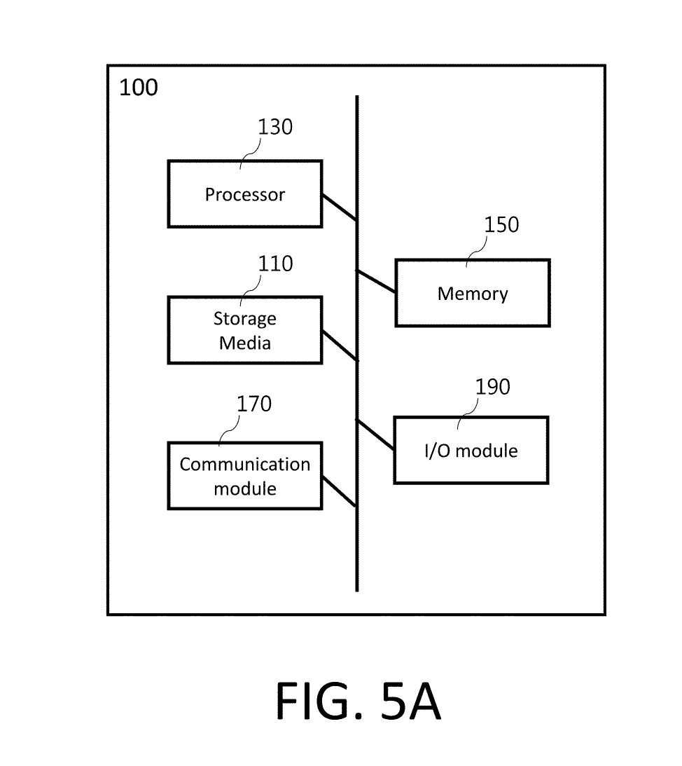

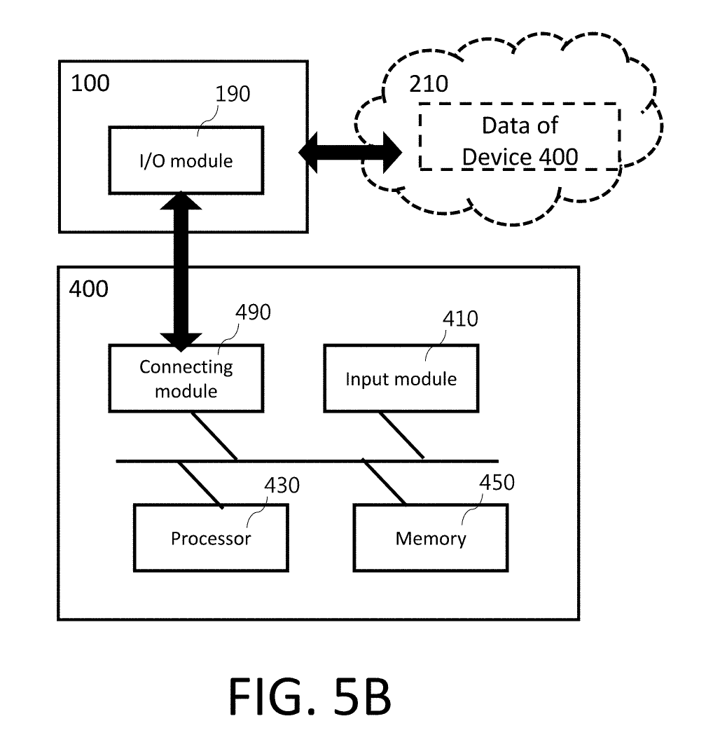

FIG. 5A illustrates an exemplary client device 100 in accordance with some embodiments of the present disclosure. As described in previous paragraphs, the client device 100 may optionally include a local storage medium 110 for providing cache storage 470 in some implementations. In addition, the client device 100 may generally include a processor 130 for executing instructions of the operating system 400 and applications, a memory 150 connected to the processor for temporarily keeping data contents to be process by the processor 130, a communication module 170 for accessing the network 300 for uploading/downloading data contents to/from the cloud storage server cluster 200 and an Input/output (I/O) module 190 for receiving user commands for manipulating data contents and presenting processed data contents to a user of the client device 100. The local storage medium 110 may be a computer readable recording medium embedded in the client device 100 and may further include ROM, RAM, EPROM, EEPROM, hard disk, solid state drive, soft disk, CD-ROM, DVD-ROM or other forms of electronic, electromagnetic or optical recording medium. In some implementations, the local storage medium 110 may further be one or more interfaces capable of accessing the aforementioned computer readable recording medium instead. The processor 130 may be a processor or a controller for executing the program instruction in the memory 150 and may further include an embedded system or an application specific integrated circuit (ASIC) having embedded program instructions. The communication module 170 may be a wired network interface or a wireless transceiver adopting one or more of customized protocols or following existing/de facto standards such as Ethernet, IEEE 802.11 or IEEE 802.15 series, Wireless USB or telecommunication standards such as GSM, CDMAone, CDMA2000, WCDMA, TD-SCDMA, WiMAX, 3GPP-LTE, TD-LIE and LIE-Advanced. The I/O module 190 may include input device and/or output device. In some implementations, the I/O module 190 may include one or more computer peripheral input devices for receiving inputs for data manipulation such as a keyboard, a mouse and a touch pad. In some implementations, the I/O module 190 may include one or more sensors for collecting data such as an image sensor, a microphone, a global positioning system (GPS) unit, a gyroscope and other general sensors like an optical sensor, a thermo sensor or a biochemical sensor. In some implementations, the I/O module 190 may include one or more computer peripheral output devices for presenting processed data contents and interacting with a user to receive data manipulation commands such as a display, a touch screen and a speaker. In some implementations, the I/O module 190 may include one or more actuating devices for performing actions according to the processed data such as a robotic arm, a robotic rotating structure, a vehicular structure with motor adopting any kind of technologies and/or any industrial automatic control equipment. In some implementations, the I/O module 190 may include one or more connecting interfaces for data exchange between the client device 100 and the aforementioned input/output devices.

FIG. 5B illustrates an exemplary client device 100 as a peripheral device connected to another computing device 500 in accordance with some embodiments of the present disclosure. The computing device 500 may also may a processor 530, a memory 550, an input module 510 for collecting data and a connecting module 590 communicably connected the I/O module 190 of the client device 100 for data exchange. Data collected by the input module 510 may be transferred to the client device 100 through the connecting module 590 and the I/O module 190. The client device 100 may store the aforementioned data received by the I/O module 190 into the storage volume 550 through the hybrid cloud file system 410. The aforementioned data may be uploaded to the storage nodes 210 by the synching management module 440 to be stored in an allocated storage volume therein as described in previous paragraphs. As a result, the computing device 500 may also obtain a significantly larger and extendible storage capacity (storage volume 450c) by connecting to the I/O module 190 of the client device 100. In other words, the client device 100 may act as a peripheral storage device, such as a dongle device, with significantly larger storage capacity by implementing the operating system 400 and connecting to the cloud storage server cluster 200. The aforementioned functions provided by the cloud storage system may be enabled by connecting the client device 100 to the computing device 500. The computing device 500 may therefore be any computing devices whether implemented with the operating system 400. In some implementations, the computing device 500 may not need network accessing capabilities. The client device 100 may be a dongle having network accessing capabilities for the computing device 500 connecting to the cloud storage server cluster 200, and beside network accessing capabilities, storage capacity (storage volume 450) may also be provided by the client device 100 to the computing device 500. In some implementations, the computing device 500 may also be a conventional I/O device such as a sensor device, a web camera and a surveillance camera. Data may be collected by the computing device 500 and transferred to the client device 100 for being seamlessly recorded into the cloud storage server cluster 200 without manual operations just like connected to a peripheral storage device in state of art. In some implementations, the computing device 500 may further be a zero-client computing device with an output module for presenting data manipulated in the cloud storage server cluster 200. The I/O module 190 may receive data requests from the computing device 500. The client device 100 may fetch data contents correspondingly from the cloud storage server cluster 200 by the synching management module 440 and provide the data contents to the computing device 500 through the I/O module 190. Data processing may be conducted in the computing device 500 or the client device 100. In the later case, the client device 100 may further implemented with applications for processing according to the request and providing the processed data to the computing device 500.

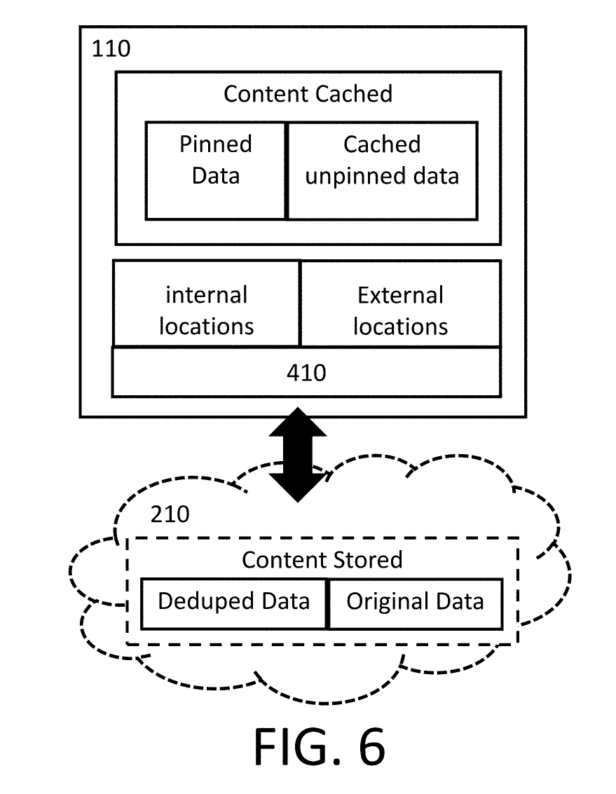

FIG. 6 illustrates an exemplary data arrangement in a cloud storage system in accordance with some embodiments of the present disclosure. Particularly, FIG. 6 shows a local storage medium 110 of the client devices (e.g., device 110a-d). In the storage volume 450 (not shown, depicted in FIG. 2) resides application/user data and a hybrid cloud file system 410 of an operating system (e.g., operating system 400), and a locally defined cache storage 470 (not shown, depicted in FIG. 2). The hybrid cloud file system 410 may provide a file system interface between the applications and an allocated space in the local storage medium 110.

To extend the storage capabilities of the storage volume 450, the data contents may be stored eventually on a remote storage backend (e.g. cloud storage nodes 210), while part of the data content is cached in the local cache storage 470 (e.g., physically in the local storage medium 110) for performance. The exemplary hybrid could file system 410 may automatically determine the data manipulation policies (e.g., data uploading, data retention, data fetch/prefetch and/or deduplication) based on the access pattern and other factors. For instance, the inclusion of the “cached unpinned data” in the local storage medium 110 may be based on the file system's own judgment (e.g., by the cache management module 430). The aforementioned “cached unpinned data” may further include data contents of applications (Apps) in some implementations such as in a mobile operating system environment.

In addition, the exemplary hybrid cloud file system module 410 may provide the user with “data pinning/unpinning” functionality. For instance, the file system management module 420 (not shown, depicted in FIG. 2) of the hybrid cloud file system module 410 may provide an interface enabling the users to elect (e.g., manually force) a particular data content to be stored in the local cache storage 470 (a “pin” action) for quick file access, thereby enhancing application performance. At a later time, a user may elect to lift this restriction (an “unpin” action), thereby allowing the originally pinned data content to be removed/replaced by other files (or portions/fragments of a file). This way, the size of data objects accessible to a client device 100 may not be limited to the size of its local storage medium 100 if (a) the maximum size of blocks is chosen appropriately, and (b) those files/directory listings are not pinned (and therefore kept in the storage backend for later access as necessary).

In some implementations, the illustrated could storage system may utilize an Android operating system. Standard Android storage volumes are typically divided into two types of storage spaces: the “Internal storage” and the “External storage”. The “Internal storage” volumes are primarily reserved for system files and application files that require protection (such as code, lib, private data, etc). The “External storage” volumes are mainly reserved for public files (such as photos, movies, music clips) and other application specific data that software applications store in such volumes. The internal storage volumes are usually formatted in a file system for Linux such as “ext2”, “ext3”, “ext4” or similar file system format. Such internal file system format generally uses strict permission models to control application or user access permissions. The External storage volumes can involve removable storage medium (such as SD-cards), and the underlying storage file system may not support strict permission models. Example of such external file system may include FAT32, vFAT, or the like. The Android external storage management allows applications to access external storage via patterns such as explicit user permission and/or restricted path specific to the application.

The exemplary hybrid cloud file system 410 may emulate the Android Storage Environment to simulate an Android storage environment with a unified cache management and single local storage backend. The volumes created in the exemplary hybrid cloud file system may be tagged as “internal” or “external” storage spaces, where the “internal” volumes simulate the “internal storage” of the Android operating system, while the “external” volumes simulate the “external storage” thereof. The local storage space (i.e., the local storage medium 110) of the Android-based client device 100 may then be allocated as cache storage for the exemplary hybrid cloud file system (i.e., a portion of which may be defined as the cache storage 470), and be used for both “internal” and “external” types of Android storage volumes. The storage space used for the exemplary hybrid cloud file system may be allocated from a single storage device or multiple storage devices, either inside the client device (e.g., device 100a-d) or attached persistently thereto. Moreover, the users may choose to “pin” particular data contents (applications, folders, or files) to the cache storage 470. A “pinned” data will nevertheless be synchronized to the remote backend (e.g., cloud serve 450), but won't be paged out from the cache storage 470, thereby enabling quick access by the client device 100.

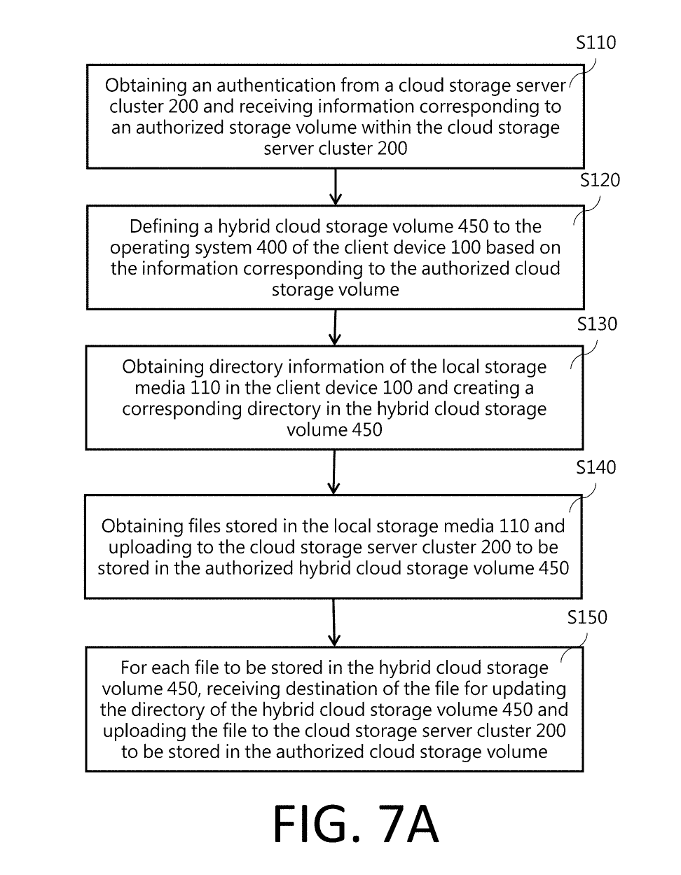

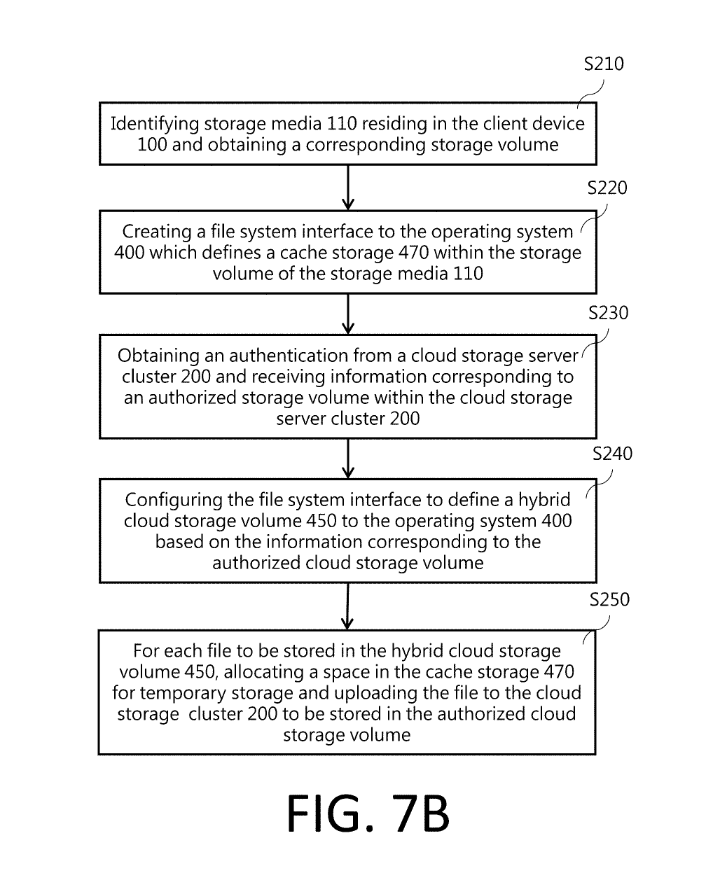

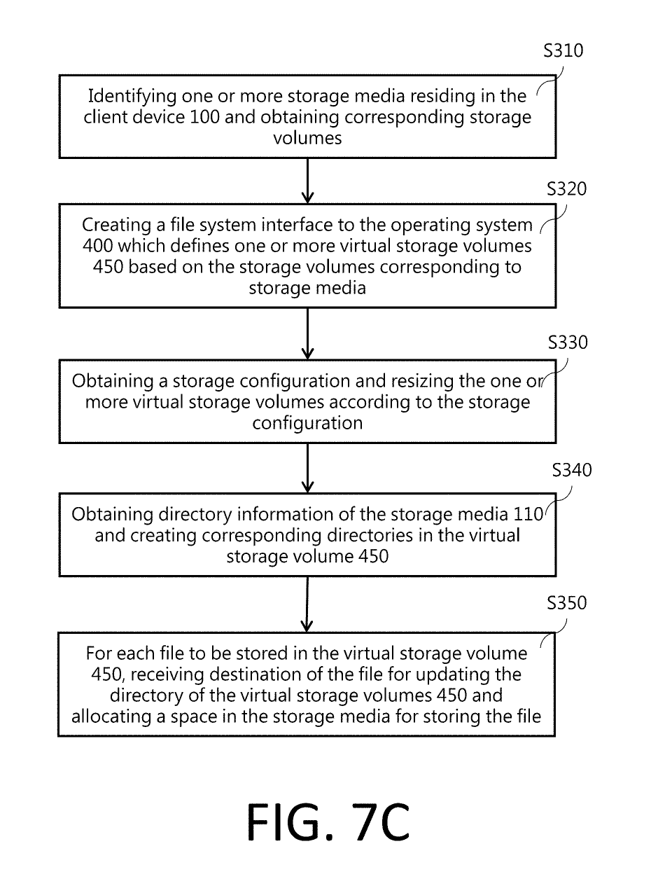

FIG. 7A illustrates an exemplary configuring process in the cloud storage system in accordance of some embodiments of the present disclosure. In some implementations, the configuring process may be initiated in booting stage of a client device 100 for the operating system 400 identifying storage media (e.g. local storage medium 100) and generating file system and storage volumes (e.g. storage volume 450a-c) accordingly. In some implementations, the configuring process may be initiated after the booting stage.

In step S110, the synching management module 440 may obtain an authentication from the cloud storage server cluster 200. The authentication may correspond to authorization and allocation of storage volume in the cloud storage server cluster 200. In some implementations, the user account and corresponding password may be received from user input. The authentication in the step S110 may need user input and be performed after the operating system booting up. In some other implementations, the information for authentication may be pre-stored in the internal storage medium for automatically obtaining authentication in the booting stage. In addition, in some implementations, device identification (e.g. IMEI of a mobile phone device) of the client device 100 may also be utilized during the authentication. For example, the cloud storage server cluster 200 may maintain a list of device identifications of client devices for determining whether a client device is authorized for accessing the storage volumes. After receiving the user account, corresponding password and the device identification from the client device 100, the cloud storage server cluster 200 may check whether the user account is authorized respectively. If the user account is authorized, the cloud storage server cluster 200 may allocate a cloud storage volume for the client device 100 by recording and mapping the device identification to the allocated storage volume. The aforementioned recording and mapping may enable the authentication of a user account corresponding to multiple client devices. In some implementations, multiple client devices may share the same cloud storage volume, or may have their own cloud storage volume respectively in some implementations.

In step S110, The synching management module 440 may further receive information corresponding to an authorized storage volume in the cloud storage server cluster 200 such as an authorized size of a cloud storage volume allocated for the client device 100 in the cloud storage server cluster 200.

In step S120, the file system management module 420 may be configured to define a hybrid cloud storage volume 450 with the authorized size in the operating system 400 of the client device 100 based on the information received in step S110. In some implementations, multiple cloud storage volumes in different cloud storage sources (including ones other than the cloud storage server cluster 200) may be applied. The file system management module 420 may receive authentication and information respectively and define the hybrid cloud storage volume 450 with a total size of the multiple cloud storage volumes.

In step S130, the file system management module 420 may obtain directory information of storage volumes corresponding to the local storage medium 110 (depicted as “local storage volume”) in the client device 100. Before setting up the hybrid cloud storage volume 450, files may have been already stored in the local storage volume. The file system management module 420 may therefore obtain the directory information of the files in the local storage and generate a copy in the hybrid cloud storage volume 450 for replacing the local storage volume with the hybrid cloud storage volume 450. And then in step S140, the synching management module 440 may obtain the files in the local storage volume (in the local storage medium 110) and upload to the cloud storage server cluster 200. As a result, the files in the local storage volume will be substantially moved to the hybrid cloud storage volume 450 corresponding to the authorized storage volume in the cloud storage server cluster 200.

The configuration of hybrid cloud storage volume 450 may be accomplished in step S140. According to the configuration, in step S150, whenever a file is determined to be stored in hybrid cloud storage volume 450. The file system management module 420 may receive a destination of the file and update the directory of the hybrid cloud storage volume 450 according to the destination. In some implementations, metadata of the file may also be received and referenced to update the directory of the hybrid cloud storage volume 450. The synching management module 440 may then upload the file to the cloud storage server cluster 200 for storing in the authorized cloud storage volume therein. In some implementations, the file may be partitioned into data chunks having a fixed size or a fixed maximum size. The aforementioned steps may still be applied correspondingly.

FIG. 7B illustrates another exemplary configuring process in the cloud storage system in accordance of some embodiments of the present disclosure. In step S210, the file system management module 420 may also identify a storage medium 110 and obtain a corresponding storage volume depicted as the local storage volume in the previous paragraph. In step S220, the file system management module 420 may create a file system interface defining a cache storage 470 within the local storage volume. In some implementations, the whole local storage volume may be allocated for cache storage 470. In step S230, the synching management module 440 may further obtain an authentication from the cloud storage server cluster 200 corresponding to an authorized cloud storage volume therein. The synching management module 440 may also receive information such as the size of the cloud storage volume. In step S240, the file system management module 420 may configure the file interface to define a hybrid cloud storage volume 450 with the authorized size based on the information corresponding to the authorized cloud storage volume in step S230.

The configuration of hybrid cloud storage volume 450 with cache storage 470 may be accomplished in step S240. According to the configuration, in step S250, whenever a file is determined to be stored in hybrid cloud storage volume 450. The file system management module 420 may receive the destination of the file and update the directory of the hybrid cloud storage volume 450 accordingly. The cache management module 430 may allocate a space in the cache storage 470 for temporary storage. The synching management module 440 may then upload the file to the cloud storage server cluster 200 for storing in the authorized cloud storage volume therein.

FIG. 7C illustrates another exemplary configuring process in the cloud storage system in accordance of some embodiments of the present disclosure. There may be one or more storage media residing in the client device 100 or accessible by the client device 100. In some embodiments, the client device 100 may not be able to access the cloud storage server cluster 200. The hybrid cloud file system 410 may be applied to integrate the aforementioned storage media instead. In step S310, the file system management module 420 may identify the one or more storage media and obtain corresponding storage volume depicted as the local storage volumes in the previous paragraph. In step S320, the file system management module 420 may create a file system interface defining one or more virtual storage volumes 450 corresponding to the local storage volumes. In step S330, the file system management module 420 may obtain a storage configuration and resize the one or more virtual storage volumes 450 according to the storage configuration. In some implementations, the storage configuration may be provided by the user of the client device 100 or pre-stored in one of the storage media. In step S330, the file system management module 420 may obtain directory information of the local storage volumes (corresponding to the storage media) and create corresponding directories in the virtual storage volumes 450. The configuration of the virtual storage volumes 450 may be accomplished in step S340. According to the configuration, in step S350, whenever a file is determined to be stored in the virtual storage volumes 450. The file system management module 420 may receive the destination of the file and update the directory of the virtual volumes 450 accordingly. The cache management module 430 may allocate a space in the local storage volumes for storage. The aforementioned steps may be combined with the steps in FIG. 7A for integrating local storage volumes corresponding to the one or more storage media and the authorized cloud storage volume in the cloud storage server cluster 200 as depicted in FIG. 2. Multiple virtual storage volumes (such as storage volumes 450a-c as depicted in FIG. 2) may be created. Portions of the virtual storage volumes may correspond to the local storage volumes only (such as storage volumes 450a and storage volumes 450b depicted in FIG. 2) and portions of the virtual storage volumes may correspond to the authorized cloud storage volumes in the cloud storage server cluster 200 (such as storage volume 450c depicted in FIG. 2). The aforementioned steps may further be combined with the steps in FIG. 7B by allocating portion of the local storage volumes as cache storage 470 in virtual storage volume (or independent from virtual storage volume) correspond to the authorized cloud storage volume in the cloud storage server cluster 200 (depicted as the hybrid cloud storage volume). The synching management module 440 may further upload files in the cache storage 470 to the cloud storage server cluster 200 for storing in the authorized cloud storage volume therein.

The performance of the aforementioned steps is described in view of software functional blocks in the client device 100. Therefore, in view of physical hardware device, the client device 100 may be the physical entity performing all the aforementioned steps. Moreover, corresponding process performed by the cloud storage server cluster 200 are also disclosed to a person having ordinary skill in the art in the aforementioned process in FIGS. 7A, 7B and 7C. In addition, steps in FIGS. 7A, 7B and 7C may be amended, omitted or interchanged in accordance in some embodiment of the present disclosure. For example, the steps S130 and S140 may be interchanged without affecting the functionality of the present disclosure. The step S150 may be omitted if the local storage volume corresponding to the local storage medium 110 is deemed as a composition of the hybrid cloud storage volume 450 in some implementations. Similarly, modifications alike may also be applied to the other processes disclosed in FIGS. 7B and 7C.

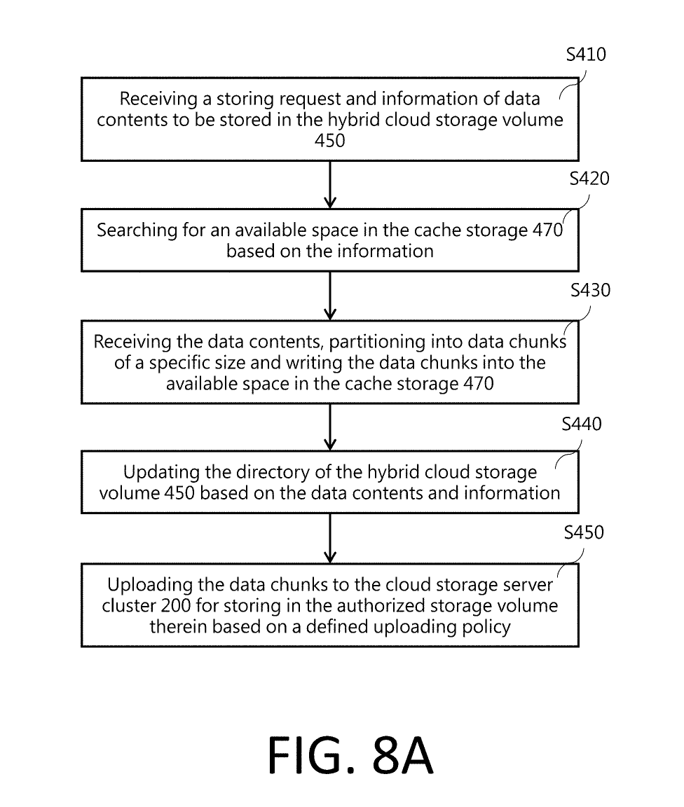

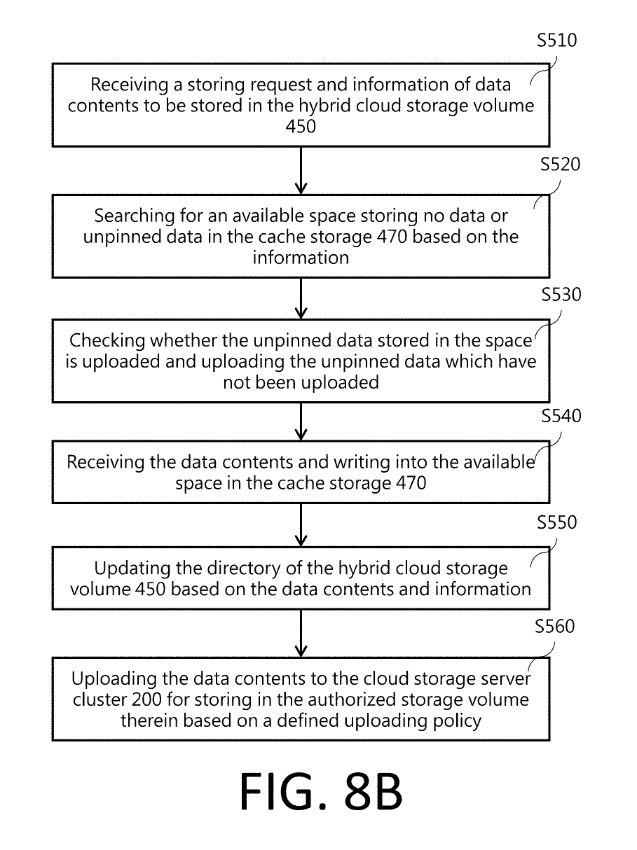

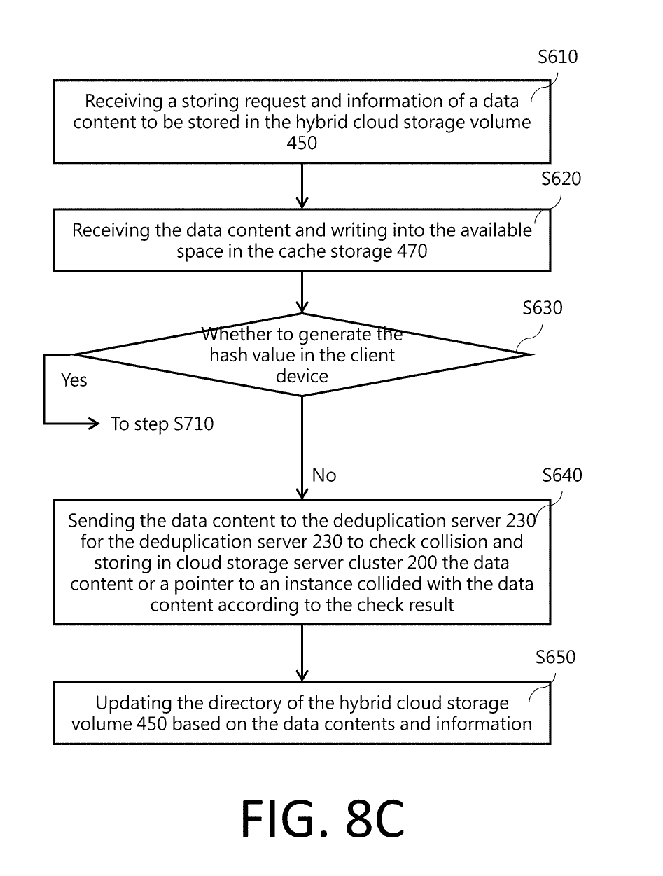

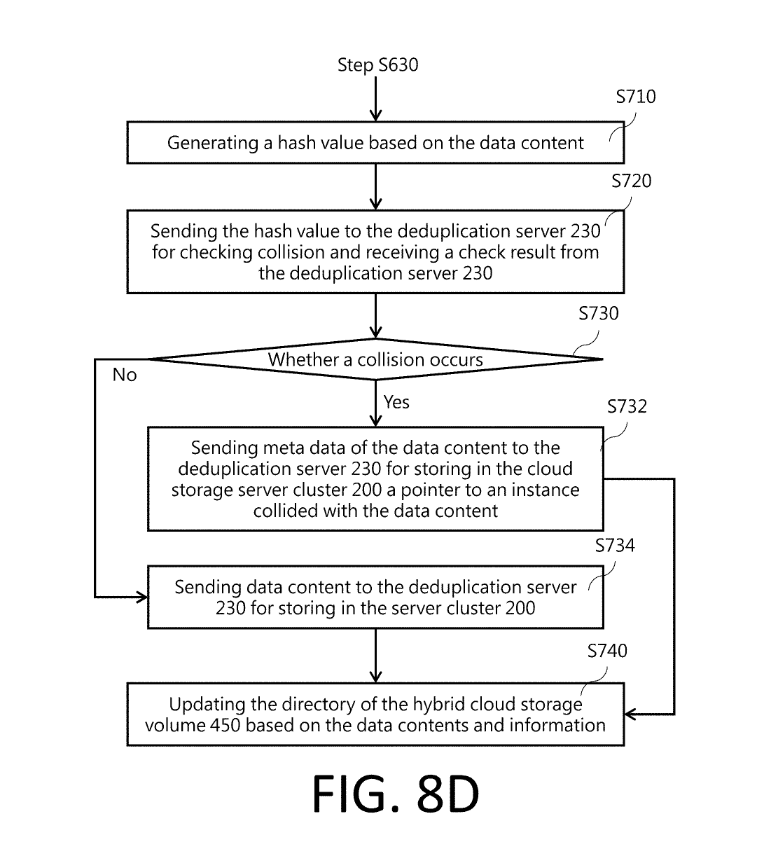

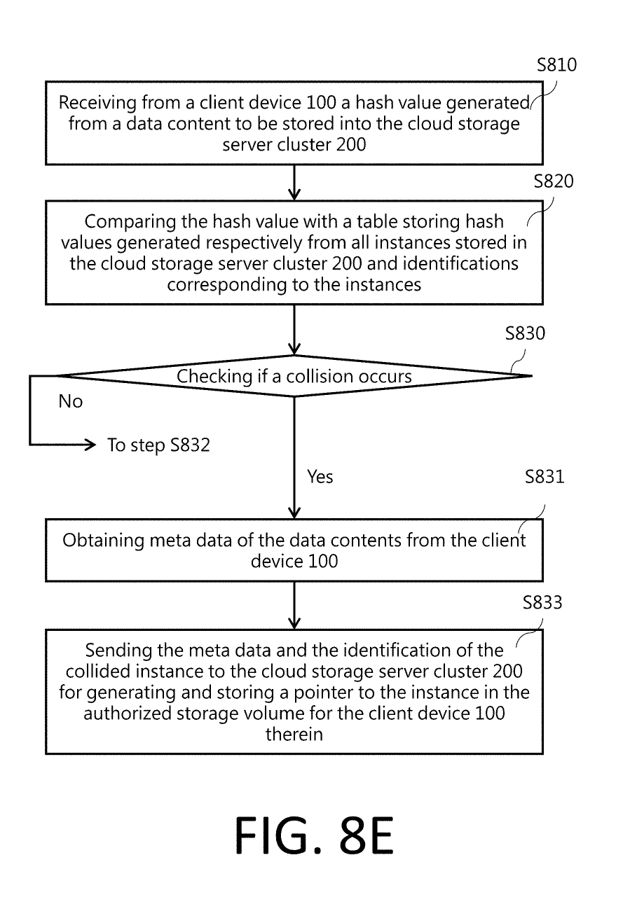

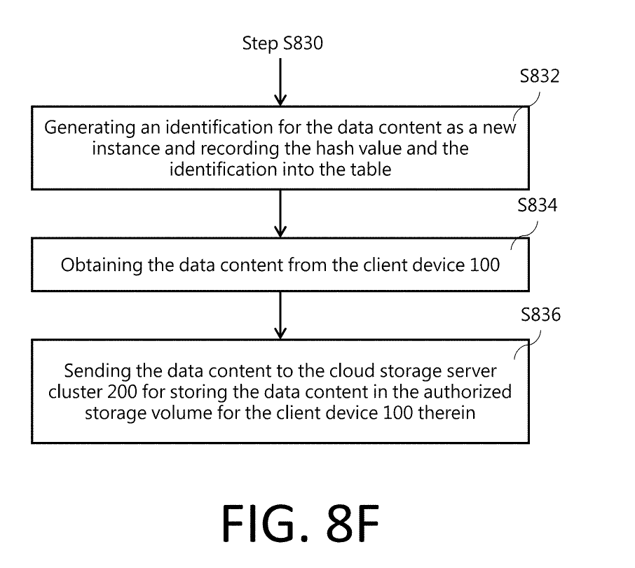

FIG. 8A illustrates an exemplary data storing process in the cloud storage system in accordance of some embodiments of the present disclosure. In step S410, the file system management module 420 may receive a storing request and information of data contents to be stored in the hybrid cloud storage volume 450. In step S420, the cache management module 430 may search for an available space in the cache storage 470 based on the information of the data contents. In step S430, the file system management module 420 may be configured to receive and partition the data contents into data chunks of a particular size. The cache management module 430 may further be configured to write the data chunks into the available space in the cache storage 470. In some implementations, the partitioning may be omitted, and the cache management module 430 may write entire files into the available space in the cache storage 470. In step S440, the file management module may update the directory of the hybrid cloud storage volume based on the data contents and the corresponding information received. In step S450, the synching management module 440 may upload the data chunks to the cloud storage server cluster for storing in the authorized volume therein based on an uploading policy. In some implementations, the uploading policy may be defined, updated and referenced for uploading by the upload management component of the synching management module 440 as described corresponding to FIG. 3 in previous paragraphs. Similarly, if the partitioning is omitted in step S430, the synching management module 440 may upload entire files to the cloud storage server cluster 200 instead. However, the partitioning of the data contents may facilitate the efficiency of cache storage and bandwidth utilization as the cache management module 430 and the synching management module 440 may schedule the storing and uploading of the partitioned data contents.

FIG. 8B illustrates an exemplary data storing process in the cloud storage system in accordance of some embodiments of the present disclosure. In some embodiments, a pinning/unpinning mechanism may be adopted in the cache storage 470. In step S510, the file system management module 420 may receive a storing request and information of data contents to be stored in the hybrid cloud storage volume 450. In step S520, the cache management module 430 may search for an available space in the cache storage 470 based on the information of the data contents. The available space in the cache storage 470 may be defined as spaces storing no data or unpinned data. However, before releasing spaces storing unpinned data, some data may not have been uploaded to the cloud storage server cluster 200 according to the uploading policy in some implementations. Therefore, in step S530, the cache management module 430 may check whether the unpinned data stored in the available space is uploaded. If the data has not been uploaded, the synching management module 440 may upload the unpinned data. In step S540, the file system management module 420 may be configured to receive the data contents, and the cache management module 430 may be configured to write the data contents into the available space in the cache storage 470. In some implementations, the data contents may be partitioned. and the cache management module 430 may write partitioned data contents into the available space in the cache storage 470. In step S550, the file system management module 420 may update the directory of the hybrid cloud storage volume based on the data contents and the corresponding information received. In step S560, the synching management module 440 may upload the data contents to the cloud storage server cluster 200 for storing in the authorized volume therein based on the aforementioned uploading policy. In some implementations, if the data contents are partitioned in step S540, the synching management module 440 may upload partitioned data contents to the cloud storage server cluster 200 instead.

FIGS. 8C and 8D illustrate an exemplary data storing process in the cloud storage system in accordance of some embodiments of the present disclosure. In some embodiments, deduplication operations may be adopted in data storing process.

Referring to FIG. 8C, in step S610, the file system management module 420 may receive a storing request and information of data contents to be stored in the hybrid cloud storage volume 450. In step S620, the file system management may receive the data content and write into the available space in the cache storage 470. In step S630, the deduplication component 443 of the synching management module 440 may determine whether to generate a hash value for checking duplication in the client device 100. In some implementations, the determination may be performed according to a deduplication policy (e.g. determined by types of the client device 100 or bandwidth available to the client device 100) as described in the paragraphs corresponding to FIG. 3. The deduplication policy may further be maintained by a deduplication server 230 as depicted corresponding to FIG. 3 in some implementations. Conversely, the deduplication policy may also be maintained in the client device 100. If the deduplication component 443 determines not to generate a hash value for checking duplication in the client device 100, in step S640, the deduplication component 443 may send the entire data content to the deduplication 230 for the deduplication server 230 checking duplication by comparing to a hash table of unique data contents (depicted as “objects” in previous paragraphs corresponding to FIG. 3) in the cloud storage server cluster 200. According to the result of checking duplication, the deduplication server 230 may store only a pointer and identification to an object having the same hash value in the hash table (if duplication occurs), or the deduplication server 230 may store the data content directly in the cloud storage server cluster 200 if no object found having the same hash value in the hash table (duplication not occurs). The deduplication server 230 may further update the hash table with the data content as a new object and record the hash value and identification of the data content into the hash table in some implementations. In step S650, the file management module may update the directory of the hybrid cloud storage volume 450 based on the data content and the corresponding information received.

Referring to FIG. 8D, if the deduplication component 443 determines to generate a hash value for checking duplication in the client device 100, in step S710, the deduplication component 443 may generate a hash value locally based on the data content. In step S720, the deduplication component 443 may further send the hash value to the deduplication server 230 for checking if duplication occurs. By sending only the hash value to the deduplication server 230, the bandwidth required for the transmission may be reduced. In step S730, the deduplication component 443 may receive a checking result from the deduplication server 230. And if duplication occurs, in step S732, the deduplication component 443 may send metadata of the data content to the duplication server 230. The duplication server 230 may store a pointer to the object duplicated with the data content and identification of the object in the storage nodes 210 of the cloud storage server cluster 200 instead of the data content for sparing storage capacity. The duplication server 230 may also store the metadata for generating the data content based on the object and the metadata in the cloud storage server cluster 200 in response to future file requests for the data contents from the client device 100. Conversely, if duplication not occurs, in step S734, the deduplication component 443 may send the entire data content to the duplication server 230. In some implementations, the deduplication server 230 may further update the hash table with the data content as a new object and record the hash value and identification of the data content into the hash table as depicted in step S640. Whether duplication occurs, in step S740, the file system management module 420 may update the directory of the hybrid cloud storage volume 450 based on the data content and the corresponding information received.

FIGS. 8E and 8F illustrate an exemplary data storing process in the cloud storage system in accordance of some embodiments of the present disclosure. In some embodiments, deduplication operations may be adopted in data storing process. However, on contrary to the process performed in the client device 100 in FIGS. 8C and 8D, the illustration in FIGS. 8E and 8F may correspond to the process performed by the deduplication server 230.

Referring to FIG. 8E, in step S810, the deduplication server 230 may receive from the client device 100 a hash value generated thereby in association with a data content to be stored into the cloud storage server cluster 200. In step S820, the deduplication server 230 may compare the hash value with the hash table which stores identifications of/hash values generated respectively from all the objects (unique data contents) stored in the cloud storage server cluster 200. In step S830, the deduplication server 230 may check if duplication occurs (whether the same hash value is found in the hash table). If duplication occurs, in step S831, the deduplication server 230 may obtain metadata of the data content from the client device 100. In step S833, the deduplication server 230 may further send the metadata and the identification of the duplicated object to the storage nodes 210 for the storage nodes 210 generating a pointer to the object and storing into the authorized storage volume corresponding to the client device 100 therein. In some implementations, the management server 220 may assign storage nodes 210 for storing data contents or pointers instead. Therefore, the deduplication server 230 may send metadata to the management server 220 correspondingly.

Referring to FIG. 8F, if duplication not occurs, in step S832, the deduplication server 230 may generate an identification for the data content as a new object and record the identification and the hash value corresponding to the new object into the hash table. In step S834, the deduplication server 230 may obtain the data content from the client device 100 by sending a request to the client device 100 and receiving the data content correspondingly. In step S836, the deduplication server 230 may send the data content to the storage nodes 210 for storing the data content into the authorized storage volume for the client device 100 therein.

In some embodiments, the hash algorithm adopted in the client device 100 may have comparatively lower computing complexity than that might otherwise be implemented by the deduplication server 230, considering the client device 100 may not have sufficient computing power. As a trade-off, the client-side hash values with lower complexity may result in the issuance of identical hash values for different data contents, making the different data contents non-distinguishable. As a consequence, the checking of duplication may generate a false result. For enhancing accuracy, in some implementations, multiple hash algorithms (in some cases, having varying complexities) may be adopted in the client device 100, and the hash checking process may be performed iteratively. Correspondingly, the deduplication server 230 may store multiple hash values for a single data object in the hash table. If a first hash value of a lower complexity generated from a first hash algorithm (e.g., by a client device) is found to be duplicated in the hash table, the deduplication server 230 may request a second hash value generated from a second hash algorithm from the client device 100 as a double check. For example, the steps S710 to S730 in FIG. 8D may be performed iteratively before performing step S732 or step S734 by generating multiple hash value by different hash algorithm for checking if duplication really occurs. Generally, the multiple hash value should be all found duplicated in the hash table to indicate a true duplication occurrence of data content. In some implementations, in order to save bandwidth and computing resource in the client device 100, the complexity of algorithm corresponding to the first hash value may be lower than which corresponding to the second hash value. Similar to that depicted previously, Steps S810 to S830 in FIG. 8E may also be performed iteratively before performing step S831 or step S832. However, in some implementations, the client device 100 may simply provide metadata (e.g. image size of an image file or video length of a video file) to the deduplication server 230 for double checking duplication. The deduplication server 230 may compare the metadata received from the client device and the metadata of the data objects stored in the hash table to determine if a duplication condition occurs. In some implementations, portion of data contents may also be provided instead of the metadata. In some implementations, the multiple hash algorithms and the metadata comparison process may be combined for checking duplications.

Nevertheless, the computing complexity in a client device may not be the sole consideration for the generation of the client-side hash value; other intrinsic factors (e.g., computing capability) and/or extrinsic factors (e.g., connection bandwidth, battery level, size of the data object to be transmitted) of the client device may also be taken into consideration in adopting the hash generation algorithms in the client device. The intrinsic/extrinsic factors exemplified above may correspond to an overall computing latency budget, in which each of the factors translates to a processing time budget in the client device. For example, if the client device is a smart phone having a higher processing capability, a hash generating algorithm of a higher complexity may be applied, so that an accurate determination of hash collision outcome may be reached in a shorter time. In some instances, if the connection bandwidth (e.g., wireless bandwidth) for a client device is broad enough, the client device 100 may be configured to take advantage of such condition and forward more data (e.g., the metadata of a data object alone with the hash value thereof) to the deduplication server 230 at an earlier stage (e.g., instead of performing hash generation steps iteratively). In some instances where the client device's connection bandwidth is sufficient for uploading an entire data object, the iterating hash generating steps may even be omitted, and the entire data object may be directly transmitted to the deduplication server 230 in favor of a server-side hash generation (as depicted previously). Conversely, if the connection bandwidth for a client device is not broad enough, a hash algorithm of high complexity may be adopted in the client device to generate a more sophisticated hash value that may yield higher accuracy in fewer iterations, thereby making better use of the computing power of the client device and the limited bandwidth recourses. Accordingly, in some embodiments, the deduplication component 443 of the client device may be configured so that a subsequent hash generation there-by corresponds to a lower computing latency budget than that of a previous client-side hash value.

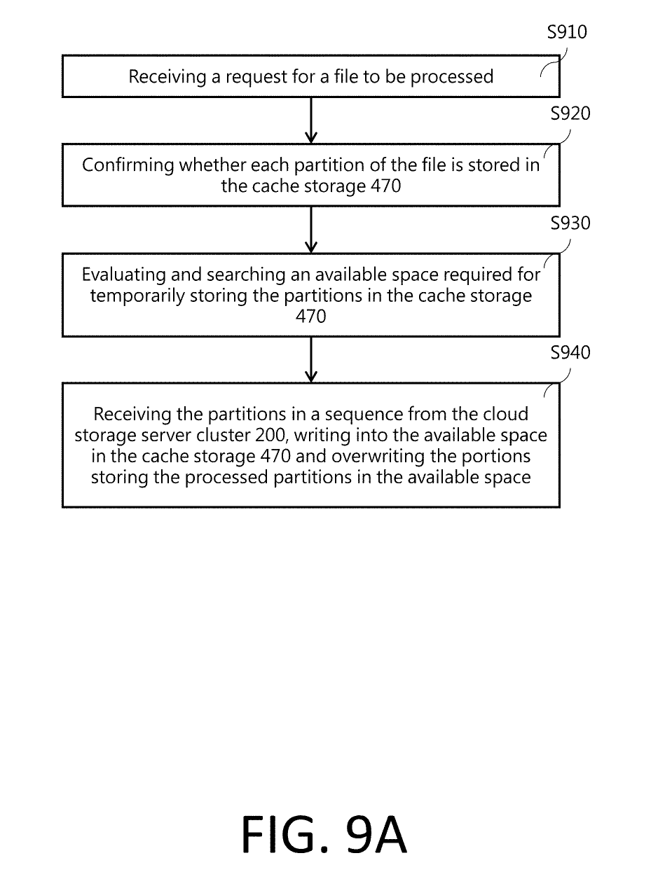

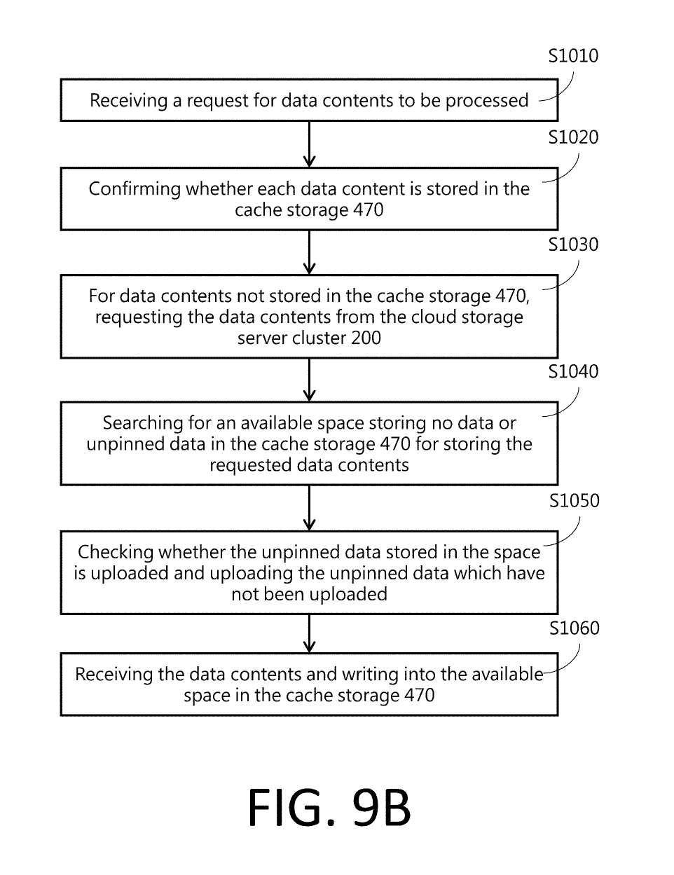

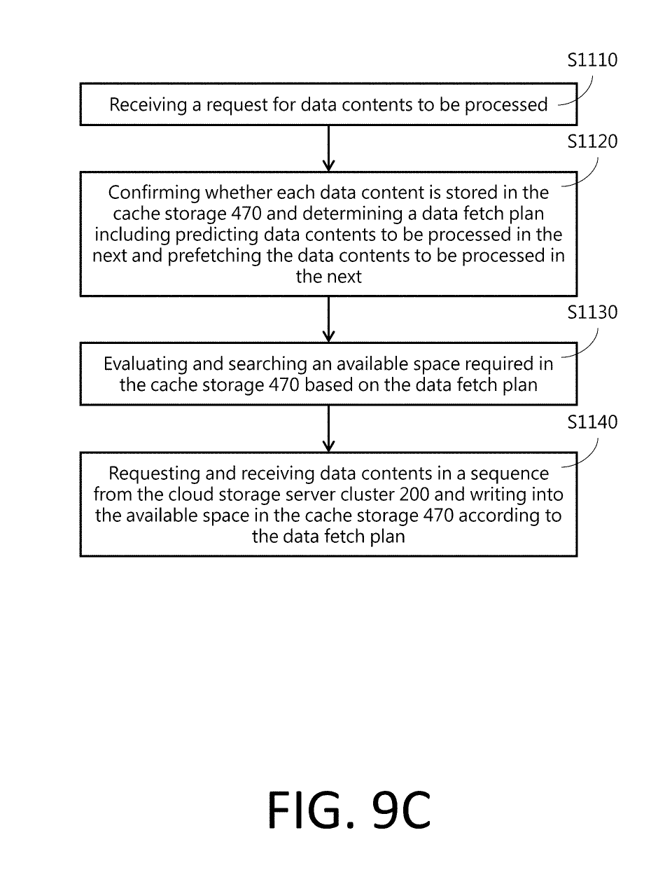

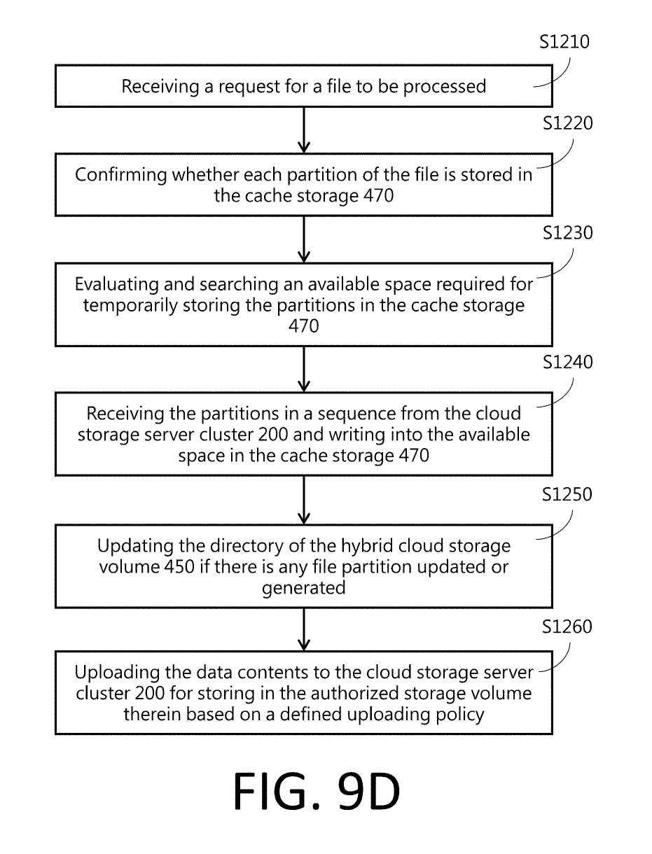

FIG. 9A illustrates an exemplary data fetch process in the cloud storage system in accordance with some embodiments of the present disclosure. In step S910, the file system management module 420 may receive a request for a file to be processed. The file to be processed may be required by application software, or the file to be processed may be part of application software to be launched by the operating system 400. In some embodiments, the file may be partitioned into data chunks, and some of the partitions may be stored in the cache storage 470. Therefore, in step S920, the cache management module 430 may confirm whether each partition of the file is stored in the cache storage 470. If some partitions of the file are stored in the cache storage 470 (cached partitions), the cached partitions may be processed at first for accelerating the file fetching and processing. If some partitions of the file are not stored in the cache storage 470 (non-cached partitions), in step S930, the cache management module 430 may evaluate and search an available space in the cache storage 470 which is required for at least temporarily storing the non-cached partitions. In step S940, the synching management module 440 may request and receive the non-cached partitions form the cloud storage sever cluster 200. The cache management module 430 may write the partitions into the available space in the cache storage 470. In some implementations, the available space allocated for the non-cached partitions in the cache storage 470 may be smaller than total storage space required for the non-cached partitions. For certain file types and corresponding applications (e.g. playing of a video file), the cache storage 470 may overwrite processed portions of the non-cached partitions by unprocessed portions in the available space. By adopting the overwriting mechanism, available space in the cache storage 470 for a file may be reduced.

FIG. 9B illustrates an exemplary data fetch process in the cloud storage system in accordance with some embodiments of the present disclosure. In some embodiments, pinning/unpinning mechanism may be applied in the cache storage 470. In step S1010, the file system management module 420 may receive a request for data contents to be processed. In step S1020, the cache management module 430 may confirm whether each data content requested is stored in the cache storage 470. In step S1030, for data contents not stored in the cache storage 470 (non-cached data contents), the synching management module 440 may request from the cloud storage server cluster 200 accordingly. In step S1040, the cache management module 430 may search an available space in the cache storage 470 which is required for storing the requested data contents. The available space may be defined as a space storing no data or storing unpinned data in some implementations. In step S1050, the synching management module 440 may check whether the unpinned data in the available space is uploaded and upload ones have not been uploaded to the cloud storage sever cluster 200. In step S1060, the synching management module 440 may receive the requested data contents from the cloud storage sever cluster 200. The cache management module 430 may write the data contents into the available space in the cache storage 470.

In some implementations, the process may end when all of the data contents in “pinned” in the cache storage 416. If any of the data contents is “unpinned”, the file system management module 414 may confirm whether each data content is stored in the cache storage 416. If any data content is not stored in the cache storage 416, the file system management module 414 may start downloading the data content from the cloud storage 450. For data contents downloaded from the cloud storage 450, the file system management module 414 may search for available storage blocks to store the data contents. In the cloud storage system of the present disclosure, a portion of the data contents may be already stored in the cache storage 416 (being cached) which can be utilized before other data contents downloaded from the cloud storage 450. Therefore, the utilization of the data contents may be pipelined and accelerated.

FIG. 9C illustrates an exemplary data fetch process in the cloud storage system in accordance with some embodiments of the present disclosure. In some embodiments, data prefetch may be applied during the data fetch process. In step S1110, the file system management module 420 may receive a request for data contents to be processed. In step S1120, the cache management module 430 may confirm whether each data content requested is stored in the cache storage 470. The fetch management component 447 of the synching management module 440 may determine a data fetch plan for downloading the data contents not stored in the cache storage 470. In some implementations, the fetch plan may include prefetch operations including predicting data contents to be processed in the next (which may not be requested) and downloading the aforementioned data contents (data contents to be processed in the next). The prefetch operations may be generated and included according to a prefetch plan determined by the prefetch management component 441 as depicted in paragraphs corresponding to FIG. 3. If any data content is not stored in the cache storage 470 (non-cached data contents), in step S1130, the cache management module 430 may evaluate and search an available space in the cache storage 470 which is required for at least temporarily storing the non-cached data contents based on the fetch plan (including the prefetch plan). In step S1140, for non-cached data contents, the synching management module 440 may request from the cloud storage server cluster 200 accordingly. The synching management module 440 may receive the requested data contents from the cloud storage sever cluster 200. The cache management module 430 may write the data contents into the available space in the cache storage 470.

FIG. 9D illustrates an exemplary data fetch process in the cloud storage system in accordance with some embodiments of the present disclosure. In some embodiments, data fetched may be further updated during the data fetch process. In step S1210, the file system management module 420 may receive a request for a file to be processed. In step S1220, the cache management module 430 may confirm whether each partition of the file is stored in the cache storage 470. If any partitions of the file are not stored in the cache storage 470 (non-cached partitions), in step S1230, the cache management module 430 may evaluate and search an available space in the cache storage 470 which is required for at least temporarily storing the non-cached partitions. In step S1240, for non-cached partitions, the synching management module 440 may request from the cloud storage server cluster 200 accordingly. The synching management module 440 may receive the requested partitions in a sequence from the cloud storage sever cluster 200. The cache management module 430 may write the data contents into the available space in the cache storage 470. If any partitions of the file are updated, in step S1250, the file system management module 420 may update the directory of the hybrid cloud storage volume 450c accordingly. In step S1260, the synching management module 440 may upload the updated file partitions to the cloud storage server cluster 200 for storing in the authorized volume therein based on the aforementioned uploading policy.

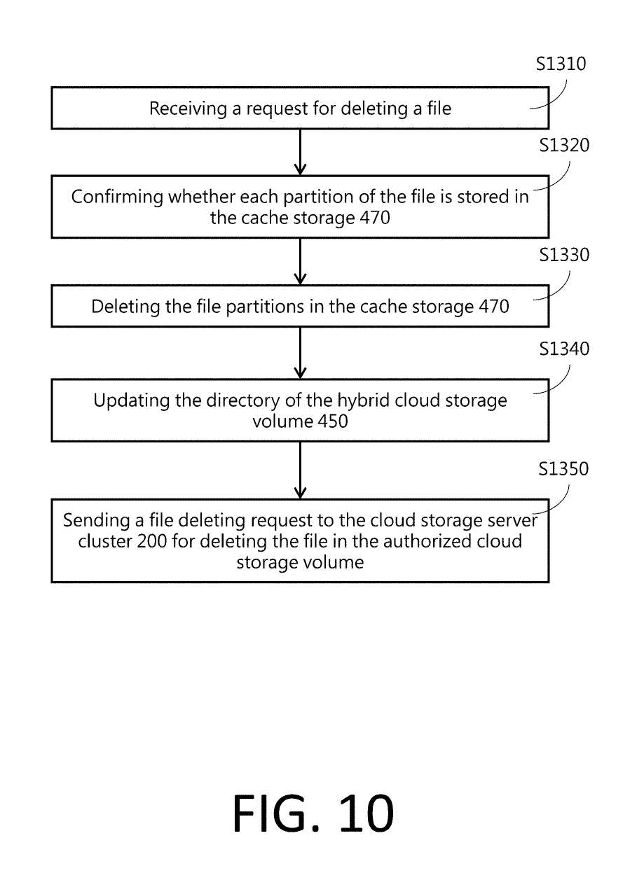

FIG. 10 illustrates an exemplary data deleting process in the cloud storage system in accordance with some embodiments of the present disclosure. In step S1310, the file system management module 420 may receive a request for a file to be deleted. In step S1320, the cache management module 430 may confirm whether each partition of the file is stored in the cache storage 470, and in step S1330, the cache management module 430 may further delete the file partitioned stored in the cache storage 470. In step S1340, the file system management module 420 may update the directory of the hybrid cloud storage volume 450c accordingly. In step S1350, the synching management module 440 may send a file deleting request to the cloud storage server cluster 200 for the cloud storage server cluster 200 deleting the file partitions in the authorized volume therein.

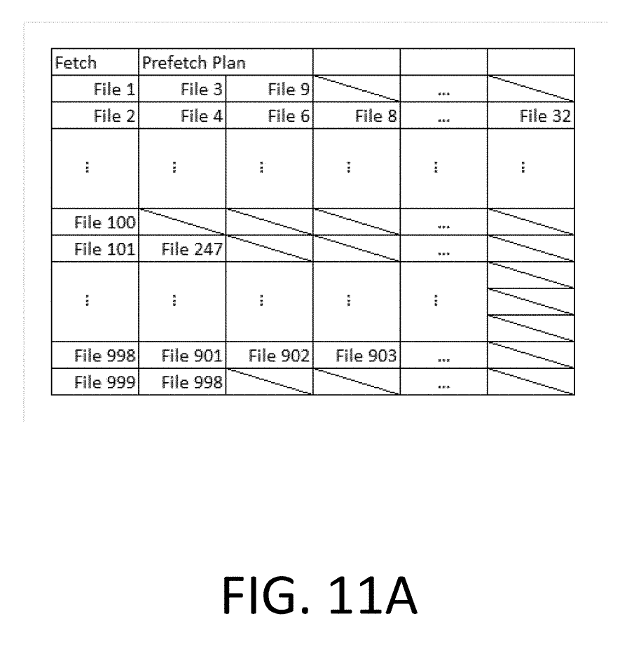

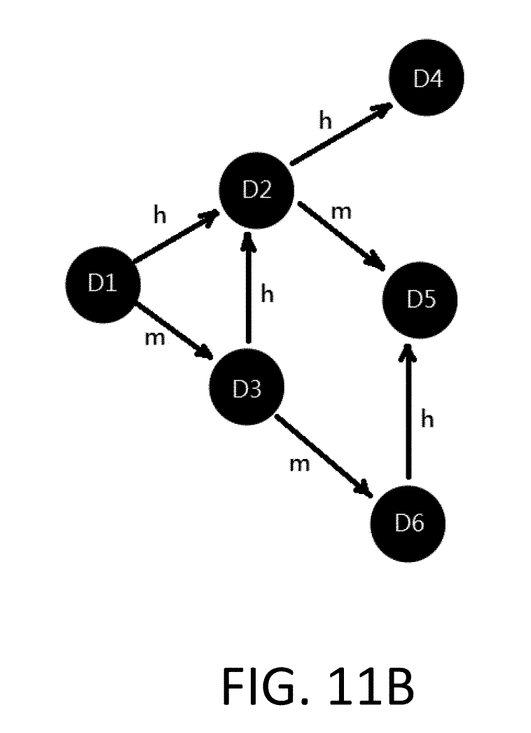

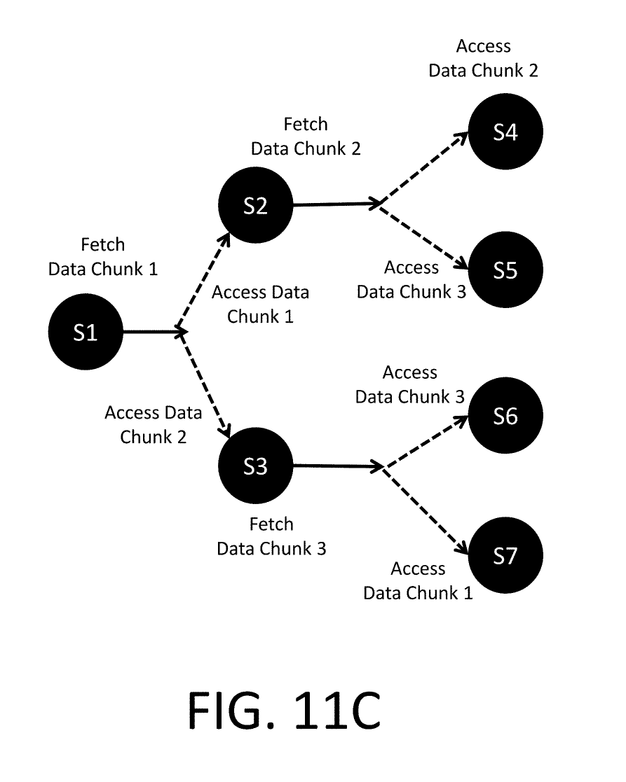

FIG. 11A illustrates an exemplary data fetch plan in accordance with some embodiments of the present disclosure. In the instant illustration, a data fetch plan in the form of a table is provided. Each row in the table represents a specific file requested, and from the second column of the table, a prefetch plan delineating the subsequent file (or a data block thereof) to be automatically fetched is provided. The prefetch management component 441 may maintain the data fetch plan. The fetch management component 447 of the synching management module 440 may request files from the cloud storage server cluster 200 accordingly. For example, the file system management module 420 may receive a file request for the “file 1” depicted in FIG. 11A. Accordingly, the synching management module 440 may request for the “file 1”, “file 3” and “file 9” from the cloud storage server cluster 200 in a sequence according to the fetch plan defined in the first row of the data prefetch table. While the table in FIG. 11 only depicts the embodiments that a file is a standard unit for data fetch, in some embodiments, partitions of files (with fixed sized) may also be a standard unit for data fetch in a data fetch plan.

In other words, the prefetch plan may include fetch relationships between files (or data contents). In some implementations, the fetch relationships may be determined based on the access relationships between files. For example, if the user behavior analysis module 140 finds that file 2 is often accessed after file 1 being accessed, the prefetch component 441 of the synching management module 440 may amend a corresponding rule—“prefetch file 2 when file 1 is accessed”. In some implementations, the information “file 2 is often accessed after file 1” may be collected by the user behavior analysis module 140 based on the file access pattern of a client implemented with the hybrid cloud file system 400 (e.g. client 100). In some implementations, the aforementioned information may be generated by the user behavior analysis server 240 (as depicted in FIG. 4) based on file access pattern information collected from multiple (or even all of) client devices implementing the hybrid cloud file system 400 of the present disclosure. For example, the user behavior analysis module 140 may collect file access patterns of the client device 100 and upload to the user behavior analysis server 240. The user behavior analysis server 240 may aggregate file access patterns collected from all the client devices to a prefetch server (not shown) for updating and/or adjusting the prefetch rules. In some implementations, the prefetch management component 441 may synch the prefetch plan with at least part of the prefetch rules from the prefetch server. While the prefetch server is amending new prefetch rules associated with the files or data contents in the storage volume of the client device 100, the prefetch management component 441 may download the prefetch rules from the prefetch server and incorporate the downloaded rules to its own prefetch plan.

FIG. 11B provides an alternative illustration of an exemplary data prefetch plan in accordance with the instant disclosure. Each circle in the instant illustration represents a data object, which may be a file or a portion thereof (e.g., a data block). The circle labeled “D1” may represent a data object requested by the fetch management component 447 of the synching management module 440. Upon the request for the data object “D1” from the cloud storage server cluster 200, the prefetch management component 441 may provide a prefetch plan that dictates the subsequent data access path among a plurality of data objects (e.g., D2, D3, etc.). For instance, the as the fetch management component 447 issues a data access request for D1, the prefetch management component 441 monitors the cache hit/miss status of the selected data object and controls the data access path in accordance with the data prefetch plan thereof. If the fetch status for D1 is a hit (as illustrated by the proceeding arrow labeled “h”), the prefetch management component 441 may automatically direct the data fetch process to a subsequent data object “D2” without further request from the fetch management component 447. Conversely, if the fetch status for the data object D1 is a miss (as illustrated by the arrow labeled “m”), the prefetch management component 441 may direct the data fetch process to a different data object “D3.” Subsequently, if the fetch for data object “D3” returns a hit, the prefetch management component 441 may direct the file fetch path back toward the data object “D2.” Likewise, if the fetch status for object “D2” is a hit, the prefetch process may be directed toward a subsequent data object “D4” (following a “hit” arrow). On the other hand, if the fetch status for “D2” is a miss, the prefetch plan may direct the fetch path toward another data object (e.g., D5). In some embodiments, the prefetch management component 441 may provide a simple and predetermined access path in the data prefetch plan for each of the data object to reduce the necessary consumption of processing power during prefetch operations, which in turn facilitates the conservation of power usage in the client device.

FIG. 11C illustrates an exemplary data fetch pattern in accordance with some embodiments of the present disclosure. In the instant illustration, the circles labeled with prefix “S” represent access pattern states. The arrows with solid lines are indicative of prefetch actions, and the arrows with dashed lines are follow-up data access actions.

The definition of “cache misses” is the situation where the system needs to access some data content in a client device (e.g., device 100), but the data content is not stored locally at that device. As such, a “download” action will be needed to transfer the required data content from the cloud storage server cluster 200. The purpose of the prefetch action is to minimize the penalties incurred by “cache misses” (e.g. the latency incurred by the need to download the requested data content). In the instant exemplary system, a prefetch action is deemed as a “hit” if the prefetched content is accessed in a reasonable timeframe after the prefetch action is done. Conversely, a prefetch action is deemed as a “miss” if the content is not accessed in that timeframe, or the data content is removed from the local storage media (e.g., cache storage 470) by some mechanism (such as a cache management mechanism) before the content can be accessed.

The performance of a prefetch mechanism can be measured by a combination of the following metrics (e.g., as a weighted summation thereof):

1. Number of prefetch hits, number of prefetch misses, or a value produced by a function of those two metrics (such as the hits/misses ratio).

2. Penalties from “cache misses” reduced by the prefetch actions.

3. Penalties incurred by prefetch misses, such as wasted bandwidth.

4. Penalties triggered by prefetch actions (such as follow-up cache misses due to cache replacement triggered by prefetch actions).

An “access pattern state” is a particular history of data accesses. An example of such a state is the sequence of files or blocks created/modified/accessed in a local device in a fixed timeframe. In some implementations, a “prefetch plan” may also be a structure of (“access pattern state”, “prefetch action”) mappings on the content of the storage system. An example of such a structure is a connected graph as illustrated in FIG. 11B.

A prefetch plan can be created manually (e.g. as human defined rules) or computed by the system from collected knowledge (databases), or a combination of both. The collected knowledge may include: the content access and creation history (e.g., if two files are always accessed in a sequential order), the content properties (e.g., file size, type, name, or any other attributes), the relation that could create some association between different data contents (e.g. if two files are in the same folder, if they are part of the same app).

In some embodiments, the prefetch plan may include relationship between data contents and be executed when data fetch occurs as depicted in previous paragraphs. In other words, the prefetch actions may be initiated by a data fetch event. However, the prefetch plan may also include rules determining data contents to be cached without being initiated by data fetch. For example, the user behavior analysis server 240 (depicted in FIG. 3) may obtain information about a file access distribution across 24 hours per day. The prefetch server (not shown) may automatically determine whether a file is to be cached and when to be cached basing on the information without the assurance of a data fetch event/request (typically manually initiated by a user action). The aforementioned rule may be incorporated into the prefetch plan, and a client device 100 that adheres to the prefetch plan may fetch the file from the cloud storage server cluster 200 at a specific time according to the rule. The user behavior analysis server 240 may obtain file access pattern among files, so that the prefetch server can determine what file/data object to be cached and when to fetch it based on the information. The aforementioned rule may be amended to the prefetch plan, and a client device 100 incorporating the prefetch plan may fetch the file from the cloud storage server cluster 200 if specific file or application is installed in the storage volume of the client device 100.

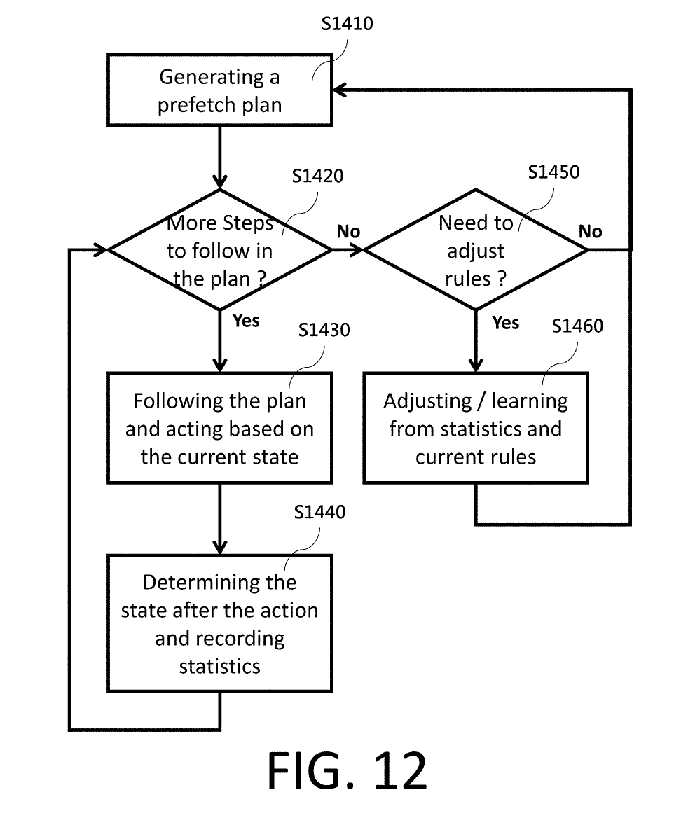

FIG. 12 is a flow chart illustrating a data fetch plan in accordance with some embodiments of the present disclosure.

In step S1410, a hybrid cloud storage system 410 in accordance with embodiments of the present disclosure may generate a prefetch plan (e.g., utilizing a prefetch management component 441).

The prefetch plan then moves to step S1410, in which the hybrid cloud storage system 410 may determine if there are more prefetch steps to follow in the prefetch plan.

If there are more prefetch steps to follow in the prefetch plan, the plan proceeds to step S1430, in which the prefetch operation follows the initial plan and acts in accordance with a current state.

The prefetch plan then proceed to step S1440, in which the hybrid cloud storage system 410 may determine the prefetch state after the prefetch action, and record the prefetch attribute status (e.g., the cache hits/misses, penalties, etc) in a prefetch record profile. The plan then iterates back to step S1420 to determine if there are more prefetch steps to follow in the plan.

Alternatively, if there is no more prefetch step to follow in the plan, the plan proceeds to step S1450, in which the hybrid cloud storage system 410 may determine if there is a need to adjust the current prefetch rules and the associated parameters.

If the system finds a need to adjust/update the prefetch parameters, the plan proceeds to step S1460, in which the prefetch rules and associated parameters are adjusted in accordance with the feedback learned from the collected statistics and the current rule settings. If the system finds no need to adjust/update the prefetch rules, or upon the application of the newly adjusted prefetch parameters, the plan proceeds back to the initial step S1410 to generate a new prefetch plan.

To simplify the resources for generating the prefetch plan, the prefetch rules can be inferred automatically or defined manually to summarize structured information found in the system. Examples could be: If two files belong to the same folder, are both images, and are created sequentially, they are likely to be accessed successively. The prefetch rules can be structures such as mathematical formulas, logical descriptions, decision structures, and takes information from the collected knowledge as inputs. Rules can be combined via parameterized formulas such as weighted summation or logical formulas. After evaluating the prefetch rules using the knowledge extracted from the databases, the output of the evaluation may be used to further generate a computed part of the plan. Rules and parameters involved in the prefetch plan generation can be re-evaluated by taking the resulting prefetch performance evaluation as feedback (e.g., through a learning scheme). After the learning process, rules and parameters could be changed to better-fit the system environment and user behavior. The processes of creating plans and learning from feedbacks need not be computed in the same place that the plan execution takes place. The evaluation of rules/parameters may take either locally collected feedback and/or globally collected feedback into account.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A computing device, comprising:
a communication element for transmitting data to one or more remote storage servers each having storage capacity allocated to the computing device and for receiving data stored in the allocated storage capacity from the remote storage servers;
a non-transitory storage medium;
one or more processors;
a non-transitory memory; and
a hybrid cloud file system element electrically coupled to the non-transitory storage medium and configured to be executed by the one or more processors, and wherein the hybrid cloud file system element is configured to:
obtain authentications for one or more authorized cloud storage volumes in the one or more remote storage servers;
define one or more hybrid cloud storage volumes each corresponding to the one or more authorized cloud storage volumes; and
define a cache storage corresponding to the one or more hybrid cloud storage volumes and allocate a storage capacity in the non-transitory storage medium for the cache storage;
wherein the hybrid cloud file system element is further configured to receive a data unpinning request for first data stored in the cache storage; and
wherein the hybrid cloud file system element is further configured to search for an available space defined as spaces storing unpinned data in the cache storage, and write other data to be stored into the available space upon receiving the other data.

2. The computing device of claim 1, wherein the computing device receives a data manipulation request for second data stored in one of the one or more hybrid cloud storage volumes, and if the second data are not stored in the cache storage but physically stored in one of the one or more authorized cloud storage volumes corresponding to the hybrid cloud storage volume:
the hybrid cloud file system element is configured to allocate a first space in the cache storage for the second data;
the hybrid cloud file system element is configured to receive the second data from the authorized cloud storage volume storing the second data; and
the hybrid cloud file system element is configured to store the second data into the first space in the cache storage.

3. The computing device of claim 2, wherein the one or more processors are configured to update the second data to generate third data;
wherein hybrid cloud file system element is configured to allocate a second space in the cache storage for the third data and store the third data in the second space; and
wherein hybrid cloud file system element is configured to upload the third data to the authorized cloud storage volume storing the second data.

4. The computing device of claim 3, wherein the hybrid cloud file system element is configured to receive a data pinning request for fourth data stored in one of the one or more hybrid cloud storage volumes; and
wherein the hybrid cloud file system element is configured to keep the fourth data stored in the cache storage and not overwritten by data to be stored in the cache storage.

5. (canceled)

6. The computing device of claim 1, wherein the hybrid cloud file system element is configured to further upload the first data to one of the one or more authorized cloud storage volumes before the first data being overwritten.

7. The computing device of claim 1, wherein the hybrid cloud file system element is configured to receive a data storing request including fifth data to be stored and a destination in a file directory of one of the one or more hybrid cloud storage volumes;
wherein the hybrid cloud file system element is configured to allocate a third space in the cache storage for the fifth data and store the fifth data into the third space;
wherein the hybrid cloud file system element is configured to upload the fifth data to an authorized cloud storage volume corresponding to the hybrid cloud storage volume where the fifth data to be stored; and
wherein the hybrid cloud file system element is configured to update the file directory of the hybrid cloud storage volume where the fifth data to be stored based on the destination in response to the data storing request.

8. The computing device of claim 7, wherein the hybrid cloud file system element is configured to upload the fifth data while bandwidth available for the computing device accessing the internet is meeting a specific level, or uploading the first file only if battery level of the computing device is exceeding a specific level, or uploading the first file if the available space for cache storage is under a specific level.

9. The computing device of claim 7, wherein the hybrid cloud file system element is configured to determine whether to keep the fifth data stored in the cache storage and no overwritten by other data to be stored in the one or more hybrid cloud storage volumes based on data access pattern of at least the one of the one or more hybrid cloud storage volumes where the fifth data is to be stored.

10. The computing device of claim 7, wherein the hybrid cloud file system element is configured to check duplication collision of the fifth data by generating a client-side hash value, sending the hash value to a deduplication server and receiving a checking result generated by comparing to information in a global hash table maintained by the deduplication server; and
the hybrid cloud file system element is configured to upload the fifth data to the authorized cloud storage volume in the one or more remote servers if the client-side hash value does not collide with respect to information in the global hash table.

11. The computing device of claim 1, further comprising an I/O module for communicably connecting to an electronic device; and
wherein the one or more processors are configured to receive the data manipulation request from the electronic device via the I/O module and send the first data to the electronic device via the I/O module in response to the data manipulation request.

12. A computing device, comprising:
a communication element for transmitting data to one or more remote storage servers each having storage capacity allocated to the computing device and receiving data stored in the allocated storage capacity from the remote storage servers;
one or more physical processors;
a non-transitory memory; and
a program, wherein the program is stored in the non-transitory memory and configured to be executed by the one or more physical processors, the program including instructions for:
obtaining by the communication element an authentication for an authorized cloud storage volume in one or more remote storage servers and corresponding volume information;
defining a hybrid cloud storage volume corresponding to the authorized cloud storage volume based on the volume information, and wherein the hybrid cloud storage volume has a file directory;
receiving a first file to be stored in the file directory of the hybrid cloud storage volume;
uploading the first file by the communication element to the authorized cloud storage volume; and
updating the file directory based on metadata of the first file;
wherein the program further includes instructions for:
allocating a first space for the first file in the cache storage;
writing the first file into the first space before uploading the first file to the authorized cloud storage volume;
uploading the first file while bandwidth available for the computing device accessing the internet is meeting a specific level, or uploading the first file only if battery level of the computing device is exceeding a specific level, or uploading the first file if the available space for cache storage is under a specific level.

13. The computing device of claim 12, further comprising a non-transitory storage medium, and wherein the program further includes instructions for:
identifying the non-transitory storage medium and obtaining a storage volume of the non-transitory storage medium;
creating a file system interface to define a cache storage within the storage volume of the non-transitory storage medium;
configuring the file system interface to replace the cache storage by the hybrid cloud storage volume after obtaining the authentication for the authorized cloud storage volume; and
uploading all files stored in the cache storage to the authorized cloud storage volume.

14. (canceled)

15. The computing device of claim 13, wherein the program further includes instructions for:
partitioning the first file into data chunks of a specific size; and
keeping at least a portion of the data chunks in the cache storage based on a data prefetch plan determining at least which data chunks of the first file are to be kept.

16. The computing device of claim 15, wherein the program further includes instructions for:
receiving a file fetch request for the first file;
allocating a space in the cache storage for the data chunks not kept in the cache storage;
obtaining by the communication element the data chunks not kept in the cache storage from the authorized cloud storage volume; and
storing the obtained data chunks into the space in response.

17. The computing device of claim 13, wherein the program further includes instructions for:
receiving a file pinning request for first file in the hybrid cloud storage volume;
keeping the first file stored in the cache storage and the first file not to be overwritten by data to be stored in the cache storage.

18. The computing device of claim 13, wherein the program further includes instructions for:
receiving a file unpinning request for first file in the hybrid cloud storage volume; and
overwriting a portion of the first file by data to be stored in the cache storage, and wherein the portion of the first file is stored in a second space allocated for the data to be stored in the cache storage.

19. The computing device of claim 12, further comprising an I/O module for communicably connecting to an electronic device, and wherein the program further includes instructions for:
receiving a data storing request and the first data from the electronic device via the I/O module.

20. A configuring method for a computing device in a cloud storage system, comprising:
obtaining an authentication for an authorized cloud storage volume in one or more remote storage servers and corresponding volume information;
defining a hybrid cloud storage volume corresponding to the authorized cloud storage volume based on the volume information, and wherein the hybrid cloud storage volume has a file directory;
receiving a first file to be stored in the file directory of the hybrid cloud storage volume;
uploading the first file to the authorized cloud storage volume; and
updating the file directory based on metadata of the first file;
wherein the configuring method further comprises:
receiving a data unpinning request for first data stored in the cache storage; and
searching for an available space defined as spaces storing unpinned data in the cache storage, and writing other data to be stored into the available space upon receiving the other data.

21. The configuring method of claim 20, further comprising:
identifying a non-transitory storage medium in the computing device to obtain a local storage volume of the local storage medium;
creating a file system interface to define a cache storage within the local storage volume;
configuring the file system interface to replace the cache storage by the hybrid cloud storage volume after obtaining the authentication for the authorized cloud storage volume; and
uploading all files stored in the cache storage to the authorized cloud storage volume.

22. The configuring method of claim 21, further comprising:
allocating a first space for the first file in the cache storage;
writing the first file into the first space before uploading the first file to the authorized cloud storage volume; and
uploading the first file while bandwidth available for the computing device accessing the internet is meeting a specific level, or uploading the first file only if battery level of the computing device is exceeding a specific level, or uploading the first file if the available space for cache storage is under a specific level.

23. The configuring method of claim 21, further comprising:
partitioning the first file into data chunks of a specific size; and
keeping at least a portion of the data chunks in the cache storage based on a data prefetch plan determining at least which data chunks of the first file are to be kept.

24. The configuring method of claim 23, further comprising:
receiving a file fetch request for the first file;
allocating a space in the cache storage for the data chunks not kept in the cache storage;
obtaining the data chunks not kept in the cache storage from the authorized cloud storage volume; and
storing the obtained data chunks into the space.

25. The configuring method of claim 21, further comprising:
receiving a file pinning request for first file in the hybrid cloud storage volume;
keeping the first file stored in the cache storage and the first file not to be overwritten by data to be stored in the cache storage.

26. (canceled)

27. A non-transitory machine readable medium storing a program for configuring a computing device comprising communication element, the program executable by at least one processing unit of the computing device, the program comprising sets of instructions for:
obtaining by the communication element an authentication for an authorized cloud storage volume in one or more remote storage servers and corresponding volume information;
defining a hybrid cloud storage volume corresponding to the authorized cloud storage volume based on the volume information, and wherein the hybrid cloud storage volume has a file directory;
receiving a first file to be stored in the file directory of the hybrid cloud storage volume;
uploading the first file by the communication element to the authorized cloud storage volume; and
updating the file directory based on metadata of the first file;
wherein the program further comprises sets of instructions for:
receiving a data unpinning request for first data stored in the cache storage; and
searching for an available space defined as spaces storing unpinned data in the cache storage, and write other data to be stored into the available space upon receiving the other data.

28. The non-transitory machine readable medium of claim 27, wherein the program further comprises a set of instructions for:
identifying a local non-transitory storage medium in the computing device to obtain a local storage volume of the local non-transitory storage medium;
creating a file system interface to define a cache storage within the local storage volume;
configuring the file system interface to replace the cache storage by the hybrid cloud storage volume after obtaining the authentication for the authorized cloud storage volume; and
uploading by the communication element all files stored in the cache storage to the authorized cloud storage volume.

29. The non-transitory machine readable medium of claim 28, wherein the program further comprises a set of instructions for:
allocating a first space for the first file in the cache storage;
writing the first file into the first space before uploading the first file to the authorized cloud storage volume; and
uploading the first file while bandwidth available for the computing device accessing the internet is meeting a specific level, or uploading the first file only if battery level of the computing device is exceeding a specific level, or uploading the first file if the available space for cache storage is under a specific level.

30. The non-transitory machine readable medium of claim 28, wherein the program further comprises a set of instructions for:
partitioning the first file into data chunks of a specific size; and
keeping at least a portion of the data chunks in the cache storage based on a data prefetch plan determining at least which data chunks of the first file are to be kept.

31. The non-transitory machine readable medium of claim 30, wherein the program further comprises a set of instructions for:
receiving a file fetch request for the first file;
allocating a space in the cache storage for the data chunks not kept in the cache storage;
obtaining the data chunks not kept in the cache storage from the authorized cloud storage volume; and
storing the obtained data chunks into the space in response to the file fetch request.

32. The non-transitory machine readable medium of claim 28, wherein the program further includes instructions for:
receiving a file pinning request for first file in the hybrid cloud storage volume;
keeping the first file stored in the cache storage and the first file not to be overwritten by data to be stored in the cache storage.

33. (canceled)

34. The non-transitory machine readable medium of claim 27, wherein the computing device comprises an I/O module for communicably connecting to an electronic device, and wherein the program further comprises a set of instructions for receiving a file storing request and the first data from the electronic device via the I/O module.
